(19) United States
(12) Patent Application Publication
(10) Pub. No.: US 2009/0147278 A1
(43) Pub. Date: Jun. 11, 2009

(54) Line Head and Image Forming Apparatus Using the Line Head

(75) Inventors: Kiyoshi Tsujino, Matsumoto-shi (JP); Nozomu Inoue, Matsumoto-shi (JP); Yujiro Nomura, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/327,664

(22) Filed: Dec. 3, 2008

(30) Foreign Application Priority Data
Dec. 5, 2007 (JP) 2007-314661
Sep. 8, 2008 (JP) 2008-229974

(51) Int. Cl. G06K 15/10

(52) U.S. Cl. 358/1.8

(57) ABSTRACT

A line head includes a head substrate, a first light-emitting element group having first light-emitting elements, a second light-emitting element group having second light-emitting elements, a first wiring line disposed on the head substrate and electrically connected to the first light-emitting elements, a second wiring line disposed on the head substrate and electrically connected to the second light-emitting elements, a first connecting unit disposed on one side of the head substrate and electrically connected to the first wiring line, and a second connecting unit disposed on the other side of the head substrate and electrically connected to the second wiring line.

### CROSS REFERENCE TO RELATED ART

The disclosure of Japanese Patent Applications No. 2007-314661 filed on Dec. 5, 2007 and No. 2008-229974 filed on Sep. 8, 2008 including specification, drawings and claims is incorporated herein by reference in its entirety.

### BACKGROUND

1. Technical Field

The present invention relates to a line head that focuses, with lenses, light beams emitted from light-emitting elements and an image forming apparatus using the line head.

2. Related Art

In such a line head, for example, as disclosed in JP-A-2007-290303, a plurality of light-emitting elements arranged in a longitudinal direction (an X direction in the document) are arrayed in two rows and in a zigzag (see FIG. 3, etc. of the document). These light-emitting elements are formed on a head substrate. A light-emitting operation of the light-emitting elements is controlled by a controller provided on the outside of the head substrate. The control of the light-emitting elements by the controller provided on the outside of the head substrate can be realized by using, for example, connecting members such as flexible printed boards called FPCs (flexible printed circuits).

One ends of the FPCs are attached to the head substrate. The other ends of the FPCs are drawn out to the outside of the head substrate. Wiring lines drawn out from the light-emitting elements are connected to the one ends of the FPCs. When a light-emission control signal from the controller is inputted to the other ends of the FPCs, the light-emitting elements emit light beams on the basis of the light-emission control signal. The light beams are focused by a graded index rod lens array. The surface of a latent-image bearing member such as a photosensitive member is exposed to the light beams.

To make it possible to perform exposure at higher resolution, a line head in which a plurality of light-emitting elements are grouped for each light-emitting group can be used. In the line head, a plurality of light-emitting element groups are arranged in a longitudinal direction to form a light-emitting element group row and a plurality of the light-emitting element group rows are arranged in a latitudinal direction. The light-emitting element group rows are shifted from one another in the longitudinal direction. As a result, positions of the light-emitting element groups in the longitudinal direction are different from one another. A focusing lens is provided for each of the light-emitting element groups. A light beam emitted from the light-emitting element group is focused by the focusing lens.

However, in the line head in which the plurality of light-emitting element group rows are arranged in the latitudinal direction, positions for attaching connecting members such as FPCs to a head substrate may be inappropriate. In such a case, when a connecting member is attached only on one side of the head substrate in the latitudinal direction, all wiring lines connected to the light-emitting element groups need to be drawn out to one side of the head substrate. As a result, a degree of freedom of the wiring lines falls.

### SUMMARY

An advantage of some aspects of the invention is to provide a technique for making it possible to draw out wiring lines connected to light-emitting element groups to both sides in a latitudinal direction and improving a degree of freedom of the wiring lines connected to light-emitting elements.

According to an aspect of the invention, there is provided a line head including: a head substrate; a first light-emitting element group having first light-emitting elements; a second light-emitting element group having second light-emitting elements; a first wiring line disposed on the head substrate and electrically connected to the first light-emitting elements; a second wiring line disposed on the head substrate and electrically connected to the second light-emitting elements; a first connecting unit disposed on one side of the head substrate and electrically connected to the first wiring line; and a second connecting unit disposed on the other side of the head substrate and electrically connected to the second wiring line.

According to the aspect of the invention, there is provided an image forming apparatus including: a head substrate; a first light-emitting element group having first light-emitting elements; a second light-emitting element group having second light-emitting elements; a first wiring line disposed on the head substrate and electrically connected to the first light-emitting elements; a second wiring line disposed on the head substrate and electrically connected to the second light-emitting elements; a first connecting unit disposed on one side of the head substrate and electrically connected to the first wiring line; a second connecting unit disposed on the other side of the head substrate and electrically connected to the second wiring line; and a controller that outputs a light-emission control signal for controlling light emission of the light-emitting elements.

As described above, according to the aspect of the invention, the line head and the image forming apparatus include the head substrate, the first light-emitting element group having the first light-emitting elements, and the second light-emitting element group having the second light-emitting elements. The first wiring line electrically connected to the first light-emitting elements and the second wiring line electrically connected to the second light-emitting elements are disposed on the head substrate. The first connecting unit electrically connected to the first wiring line is disposed on one side of the head substrate. The second connecting unit electrically connected to the second wiring line is disposed on the other side of the head substrate. In other words, the connecting sections are provided on both the sides of the head substrate. Therefore, the first wiring line electrically connected to the first light-emitting elements is electrically connected to the first connecting unit of the head substrate. The second wiring line electrically connected to the second light-emitting elements is electrically connected to the second connecting unit of the head substrate. Consequently, a degree of freedom of the wiring lines electrically connected to the light-emitting elements is improved.

Preferably, on the head substrate, N (N is an integer equal to or larger than 2) light-emitting element group rows having light-emitting element groups disposed in a first direction are disposed from one side to the other side in a second direction orthogonal to or substantially orthogonal to the first direction. The first light-emitting element group is included in a first light-emitting element group row and the second light-emitting element group is included in an Nth light-emitting element group row. With such a configuration, the first wiring line electrically connected to the first light-emitting elements belonging to the first light-emitting element group included in the first light-emitting element group row is electrically connected to the first connecting unit and the second wiring line electrically connected to the second light-emitting elements belonging to the second light-emitting element group included in the Nth light-emitting element group row is electrically connected to the second connecting unit. Therefore, it is possible to reduce the length of the first wiring line and the second wiring line and easily design the wiring lines.

Further, preferably, on the head substrate, 2M (M is a positive integer) light-emitting element group rows having light-emitting element groups disposed in the first direction are disposed from one side to the other side in the second direction orthogonal to or substantially orthogonal to the first direction. The first light-emitting element group is included in any one of a first light-emitting element group row to an Mth light-emitting element group row and the second light-emitting element group is included in any one of an (M+1)th light-emitting element group row to a 2Mth light-emitting element group row. With such a configuration, the first wiring line and the second wiring line do not overlap in the second direction. It is possible to prevent the first wiring line and the second wiring line from being formed longer than necessary.

Preferably, wiring lines electrically connected to the light-emitting elements belonging to the first light-emitting element group row to the Mth light-emitting element group row are electrically connected to the first connecting unit. Wiring lines electrically connected to the light-emitting elements belonging to the (M+1)th light-emitting element group row to the 2Mth light-emitting element group row are electrically connected to the second connecting unit. With such a configuration, the wiring lines electrically connected to the first connecting unit and the wiring lines electrically connected to the second connecting unit do not overlap in the second direction. It is possible to prevent the wiring lines from being formed longer than necessary.

Preferably, the line head and the image forming apparatus include: a first connecting circuit electrically connected to the first connecting unit of the head substrate; and a second connecting circuit electrically connected to the second connecting unit of the head substrate. With such a configuration, it is possible to easily perform electrical connection of the head substrate to the outside via the first connecting circuit and the second connecting circuit.

Preferably, the line head and the image forming apparatus include: a first electric circuit that is electrically connected to the first connecting unit of the head substrate via the first connecting circuit and outputs driving signals for driving the light-emitting elements on the basis of an inputted light-emission control signal; and a second electric circuit that is electrically connected to the second connecting unit of the head substrate via the second connecting circuit and outputs driving signals for driving the light-emitting elements on the basis of an inputted light-emission control signal. With such a configuration, the first electric circuit is electrically connected to the first connecting unit of the head substrate via the first connecting circuit and the second electric circuit is electrically connected to the second connecting unit of the head substrate via the second connecting circuit. Therefore, it is possible to improve a degree of freedom of wiring lines and design of the first electric circuit and the second electric circuit.

Preferably, the line head and the image forming apparatus include: a first driving substrate on which the first electric circuit is disposed; and a second driving substrate on which the second electric circuit is disposed. With such a configuration, the first electric circuit is disposed on the first driving substrate and the second electric circuit is disposed on the second driving substrate separately from the first and second connecting circuits and the head substrate. Therefore, it is possible to improve a degree of freedom of wiring lines and design of the first electric circuit and the second electric circuit.

Preferably, the line head and the image forming apparatus include: a first electric circuit that is electrically connected to the first connecting unit of the head substrate not via the first connecting circuit and outputs driving signals for driving the light-emitting elements on the basis of an inputted light-emission control signal; and a second electric circuit that is electrically connected to the second connecting unit of the head substrate not via the second connecting circuit and outputs driving signals for driving the light-emitting elements on the basis of an inputted light-emission control signal. The first electric circuit and the second electric circuit are disposed on the head substrate. With such a configuration, it is possible to arrange the electric circuits relatively close to the light-emitting elements. Therefore, it is possible to supply driving signals with little dullness due to stray capacitance and the like to the light-emitting elements.

Preferably, the line head and the image forming apparatus include: a first electric circuit that is provided in the first connecting circuit and outputs driving signals for driving the light-emitting elements on the basis of an inputted light-emission control signal; and a second electric circuit that is provided in the second connecting circuit and outputs driving signals for driving the light-emitting elements on the basis of an inputted light-emission control signal. With such a configuration, since the electric circuits are not disposed on the head substrate, it is possible to reduce an area of the head substrate.

Preferably, the line head and the image forming apparatus include: a first driving circuit that is provided in the first connecting circuit and outputs driving signals corresponding to amounts of emitted light of the light-emitting elements on the basis of an inputted light-emission control signal; a first holding circuit that is provided in the wiring lines electrically connected to the first connecting unit of the head substrate and holds the driving signals outputted from the first driving circuit; a second driving circuit that is provided in the second connecting circuit and outputs driving signals corresponding to amounts of emitted light of the light-emitting elements on the basis of an inputted light-emission control signal; and a second holding circuit that is provided in the wiring lines electrically connected to the second connecting unit of the head substrate and holds the driving signals outputted from the second driving circuit. With such a configuration, the driving signals outputted from the first driving circuit are held by the first holding circuit and the driving signals outputted from the second driving circuit are held by the second holding circuit. Therefore, it is possible to simplify a circuit configuration of the first driving circuit and the second driving circuit and realize simplification of circuit design and a reduction in cost of the circuits.

According to another aspect of the invention, there is provided a line head having a plurality of light-emitting elements provided to be grouped for each of light-emitting element groups and wiring lines connected to the light-emitting elements and including a head substrate on which a plurality of light-emitting element group rows, in which a plurality of the light-emitting groups are arranged in a first direction, are provided in a second direction orthogonal to or substantially orthogonal to the first direction. Connecting members having first ends attached to the head substrate and second ends to which signals related to a light-emission control signal outputted by a controller on the outside of the head substrate can be inputted are respectively provided in the one area further on one side than the respective light-emitting element groups of the head substrate in the second direction and the other area on the opposite side of the one area across the respective light-emitting element groups. The first end of the connecting member provided in the one area is connected to the wiring lines, which are drawn out to the one area, via or not via an electric circuit. The first end of the connecting member provided in the other area is connected to the wiring lines, which are drawn out to the other area, via or not via an electric circuit.

According to this aspect of the invention, there is provided an image forming apparatus including: a line head having a plurality of light-emitting elements provided to be grouped for each of light-emitting element groups and wiring lines connected to the light-emitting elements and having a head substrate on which a plurality of light-emitting element group rows, in which a plurality of the light-emitting groups are arranged in a first direction, are provided in a second direction orthogonal to or substantially orthogonal to the first direction; and a controller that outputs a light-emission control signal for controlling light emission of the light-emitting elements of the line head. Connecting members having first ends attached to the head substrate and second ends to which signals related to a light-emission control signal outputted by a controller on the outside of the head substrate can be inputted are respectively provided in the one area further on one side than the respective light-emitting element groups of the head substrate in the second direction and the other area on the opposite side of the one area across the respective light-emitting element groups. The first end of the connecting member provided in the one area is connected to the wiring lines, which are drawn out to the one area, via or not via an electric circuit. The first end of the connecting member provided in the other area is connected to the wiring lines, which are drawn out to the other area, via or not via an electric circuit.

As described above, according to this aspect of the invention, in the line head and the image forming apparatus, the connecting members having the first ends attached to the head substrate and the second ends to which signals related to a light-emission control signal outputted by the controller on the outside of the head substrate can be inputted are provided. Moreover, the connecting members are respectively provided in the one area further on one side than the respective light-emitting element groups of the head substrate in the second direction and the other area on the opposite side of the one area across the respective light-emitting element groups. The one end of the connecting member provided in the one area is connected to the wiring lines, which are drawn out to the one area, via or not via the electric circuit. The first end of the connecting member provided in the other area is connected to the wiring lines, which are drawn out to the other area, via or not via the electric circuit. In other words, the connecting members are provided on both the sides in the second direction of the head substrate. Therefore, it is possible to draw out the wiring lines connected to the light-emitting elements in any direction of the head substrate in the second direction and improve a degree of freedom of the wiring lines connected to the light-emitting elements.

Preferably, driver ICs that convert the light-emission control signal into driving signals for driving the light-emitting elements are provided on the head substrate as electric circuits. The first ends of the connecting members are connected to the wiring lines via the driver ICs and the light-emission control signal is inputted to the second ends of the connecting members via the driver ICs. With such a configuration, it is possible to arrange the driver ICs relatively close to the light-emitting elements. Therefore, it is possible to supply driving signals with little dullness due to stray capacitance and the like to the light-emitting elements.

Preferably, driver ICs that convert the light-emission control signal into driving signals for driving the light-emitting elements are provided on a driver IC substrate separate from the head substrate. The first ends of the connecting members are connected to the wiring lines and the second ends of the connecting members are connected to the driver ICs to input the driving signals to the second ends from the driver ICs. With such a configuration, the driver ICs are provided on the driver IC substrate separate from the head substrate. Therefore, it is possible to relatively freely arrange and lay out the driver ICs and hold down cost of the driver ICs.

Preferably, driver ICs that convert the light-emission control signal into driving signals for driving the light-emitting elements are provided between the first ends and the second ends of the connecting members. The first ends of the connecting members are connected to the wiring lines, the light-emission control signal is inputted to the second ends of the connecting terminals, and the light-emission control signal inputted to the second terminals is converted into the driving signals by the driver ICs and the driving signals are outputted from the first ends. With such a configuration, since it is unnecessary to provide the driver ICs on the head substrate, it is possible to reduce the size of the head substrate and configure the line head compact.

Preferably, in each of the one area and the other area, the wiring lines drawn out to the area are collectively drawn out from one place in the first direction. The first ends of the connecting members are connected to the respective wiring lines. With such a configuration, one connecting member only has to be attached to the head substrate in each of the one area and the other area. Since steps for attaching the connecting member can be reduced, it is possible to hold down manufacturing cost.

Preferably, the respective light-emitting elements are driven in a time division manner. With such a configuration, it is possible to reduce the number of driver ICs and hold down manufacturing cost.

### BRIEF DESCRIPTION OF THE DRAWINGS

The invention will be described with reference to the accompanying drawings, wherein like numbers reference like elements.

FIG. 1 is a diagram for explaining terms used in this specification.

FIG. 2 is a diagram for explaining terms used in this specification.

FIG. 3 is a diagram of an example of an image forming apparatus according to a first embodiment of the invention.

FIG. 4 is a diagram of an electric configuration of the image forming apparatus shown in FIG. 3.

FIG. 5 is a schematic perspective view of a line head according to the first embodiment.

FIG. 6 is a sectional view in a latitudinal direction of the line head shown in FIG. 5.

FIG. 7 is a schematic plan view of a lens array.

FIG. 8 is a sectional view in a longitudinal direction of the lens array.

FIG. 9 is a diagram of a configuration of a rear side of a head substrate.

FIG. 10 is a plan view of wiring lines to light-emitting element groups in the first embodiment.

FIG. 11 is a diagram of an arrangement relation between wiring line bundles and driver ICs in the first embodiment.

FIG. 12 is a diagram of a spot forming operation by the line head.

FIG. 13 is a schematic diagram of a configuration of a line head in the past.

FIG. 14 is a diagram of a light amount of a spot formed by the line head shown in FIG. 13.

FIG. 15 is a plan view of wiring lines to light-emitting element groups according to a second embodiment of the invention.

FIG. 16 is a diagram of an arrangement relation between wiring line bundles and driver ICs according to the second embodiment.

FIG. 17 is a diagram of an arrangement relation between wiring line bundles and driver ICs according to a third embodiment of the invention.

FIG. 18 is a sectional view in a latitudinal direction of a line head according to the third embodiment.

FIG. 19 is a partially enlarged view of FIG. 18.

FIG. 20 is a main part plan view of a head substrate according to the third embodiment.

FIG. 21 is a main part plan view of the head substrate according to the third embodiment.

FIG. 22 is a diagram of an arrangement relation between wiring line bundles and driver ICs according to a fourth embodiment of the invention.

FIG. 23 is a diagram of an arrangement relation between wiring line bundles and driver ICs according to a fifth embodiment of the invention.

FIG. 24 is a main part plan view of a head substrate according to a modification.

FIG. 25 is a diagram of electric connection in a form in which TFT circuits is used in addition to driver ICs.

FIG. 26 is a circuit diagram of an example of the TFT circuit.

FIG. 27 is a sectional view in a latitudinal direction of a line head in which connecting members according to a modification is shown.

### DESCRIPTION OF EXEMPLARY EMBODIMENTS

### A. Explanation of Terms

Before explaining embodiments of the invention, terms used in this specification are explained.

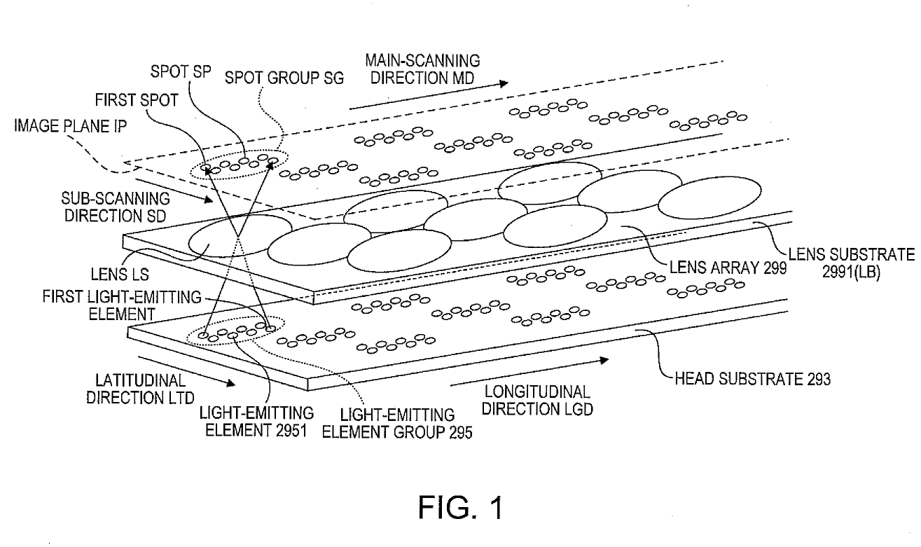

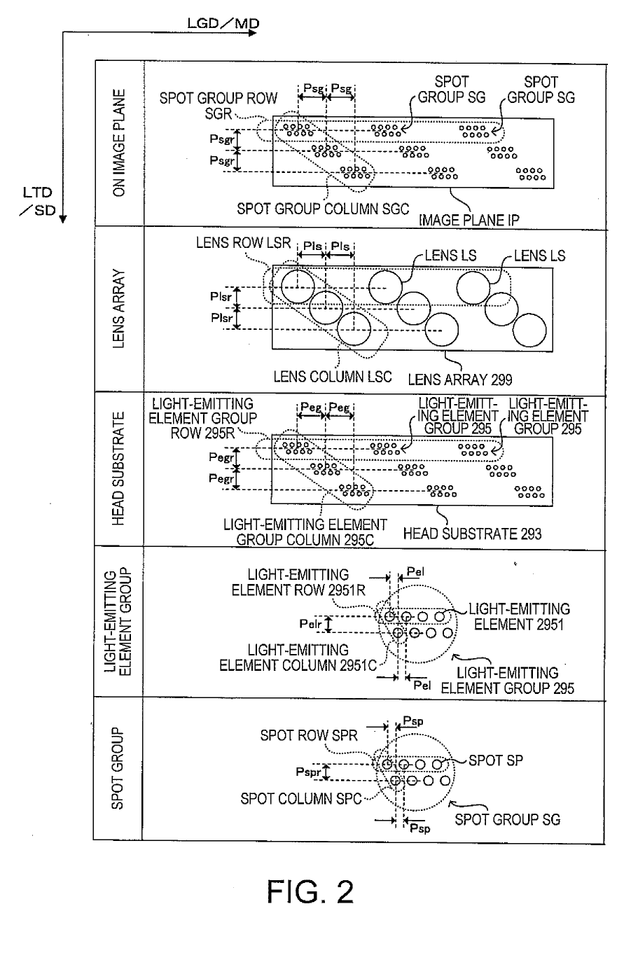

FIGS. 1 and 2 are diagrams for explaining terms used in this specification. The terms used in this specification are explained in order with reference to the figures. In this specification, a conveying direction on the surface (an image plane IP) of a photosensitive drum 21 is defined as a sub-scanning direction SD. A direction orthogonal to or substantially orthogonal to the sub-scanning direction SD is defined as a main scanning direction MD. A line head 29 is arranged with respect to the surface (the image plane IP) of the photosensitive drum 21 such that a longitudinal direction LGD thereof corresponds to the main scanning direction MD and a latitudinal direction LTD thereof corresponds to the sub-scanning direction SD.

A set of a plurality of (in FIGS. 1 and 2, eight) light-emitting elements 2951, which are arranged on a head substrate 293 in a one-to-one relation with a plurality of lenses LS of a lens array 299, is defined as a light-emitting element group 295. In other words, on the head substrate 293, the light-emitting element group 295 including the plurality of light-emitting elements 2951 is arranged with respect to each of the plurality of lenses LS. A set of a plurality of spots SP, which are formed on the image plane IP by focusing light beams from the light-emitting element group 295 toward the image plane IP with the lenses LS corresponding to the light-emitting element group 295, is defined as a spot group SG. In other words, a plurality of the spot groups SG can be formed in a one-to-one relation to a plurality of the light-emitting element groups 295. In each of the spot groups SG, a spot most upstream in the main scanning direction MD and the sub-scanning direction SD is specifically defined as a first spot. The light-emitting element 2951 corresponding to the first spot is specifically defined as a first light-emitting element.

As shown in a section “on image plane” of FIG. 2, a spot group row SGR and a spot group column SGC are defined. The plurality of spot groups SG arranged in the main scanning direction MD are defined as the spot group row SGR. A plurality of the spot group rows SGR are arranged side by side in the sub-scanning direction SD at predetermined spot group row pitch Psgr. The plurality of (in the figure, three) spot groups SG arranged at the spot group row pitches Psgr in the sub-scanning direction SD and at spot group pitches Psg in the main scanning direction MD are defined as the spot group column SGC. The spot group row pitch Psgr is a distance in the sub-scanning direction SD between geometrical centers of gravity of a pair of the spot group rows SGR adjacent to each other in the sub-scanning direction SD. The spot group pitch Psg is a distance in the main scanning direction MD between geometrical centers of gravity of a pair of the spot groups SG adjacent to each other in the main scanning direction MD.

As shown in a section “lens array” of the figure, a lens row LSR and a lens column LSC are defined. A plurality of lenses LS arranged in the longitudinal direction LSD are defined as the lens row LSR. A plurality of the lens rows LSR are arranged side by side in the latitudinal direction LTD at predetermined lens row pitches Plsr. The plurality of (in the figure, three) lenses LS arranged at the lens row pitches Plsr in the latitudinal direction LTD and at lens pitches Pls in the longitudinal direction LGD are defined as the lens column LSC. The lens row pitch Plsr is a distance in the latitudinal direction LTD between geometrical centers of gravity of a pair of the lens rows LSR adjacent to each other in the latitudinal direction LTD. The lens pitch Pls is a distance in the longitudinal direction LGD between geometrical centers of gravity of a pair of the lenses LS adjacent to each other in the longitudinal direction LGD.

As shown in a section “head substrate” of the figure, a light-emitting element group row 295R and a light-emitting element group column 295C are defined. A plurality of the light-emitting element groups 295 arranged in the longitudinal direction LGD are defined as the light-emitting element group row 295R. A plurality of the light-emitting element group rows 295R are arranged side by side in the latitudinal direction LTD at predetermined light-emitting element group row pitches Pegr. The plurality of (in the figure, three) light-emitting element groups 295 arranged at the light-emitting element group row pitches Pegr in the latitudinal direction LTD and at light-emitting element group pitches Peg in the longitudinal direction LGD are defined as the light-emitting element group column 295C. The light-emitting element group row pitch Pegr is a distance in the latitudinal direction LTD between geometrical centers of gravity of a pair of the light-emitting element group rows 295R adjacent to each other in the latitudinal direction LTD. The light-emitting element group pitch Peg is a distance in the longitudinal direction LGD between geometrical centers of gravity of a pair of the light-emitting element groups 295 adjacent to each other in the longitudinal direction LGD.

As shown in a section “light-emitting element group” of the figure, a light-emitting element row 2951R and a light-emitting element column 2951C are defined. In each of the light-emitting element groups 295, the plurality of light-emitting elements 2951 arranged in the longitudinal direction LGD are defined as the light-emitting element row 2951R. A plurality of the light-emitting element rows 2951R are arranged side by side in the latitudinal direction LTD at predetermined light-emitting element row pitches Pelr. The plurality of (in the figure, two) light-emitting elements 2951 arranged at the light-emitting element row pitches Pelr in the latitudinal direction LTD and at light-emitting element pitches Pel in the longitudinal direction LGD are defined as a light-emitting element column 2951C. The light-emitting element row pitch Pelr is a distance in the latitudinal direction LTD between geometrical centers of gravity of a pair of the light-emitting element rows 2951R adjacent to each other in the latitudinal direction LTD. The light-emitting element pitch Pel is a distance in the longitudinal direction LGD between geometrical centers of gravity of a pair of the light-emitting elements 2951 adjacent to each other in the longitudinal direction LGD.

As shown in a section “spot group” of the figure, a spot row SPR and a spot column SPC are defined. In each of the spot groups SG, the plurality of spots SP arranged in the longitudinal direction LGD are defined as the spot row SPR. A plurality of the spot rows SPR are arranged side by side in the latitudinal direction LTD at predetermined spot row pitches Pspr. The plurality of (in the figure, two) spots SP arranged at the spot pitches Pspr in the latitudinal direction LTD and at spot pitches Psp in the longitudinal direction LGD are defined as the spot column SPC. The spot row pitch Pspr is a distance in the sub-scanning direction SD between geometrical centers of gravity of a pair of the spot rows SPR adjacent to each other in the sub-scanning direction SD. The spot pitch Psp is a distance in the longitudinal direction LGD between geometrical centers of gravity of a pair of the spots SP adjacent to each other in the main scanning direction MD.

### B. First Embodiment

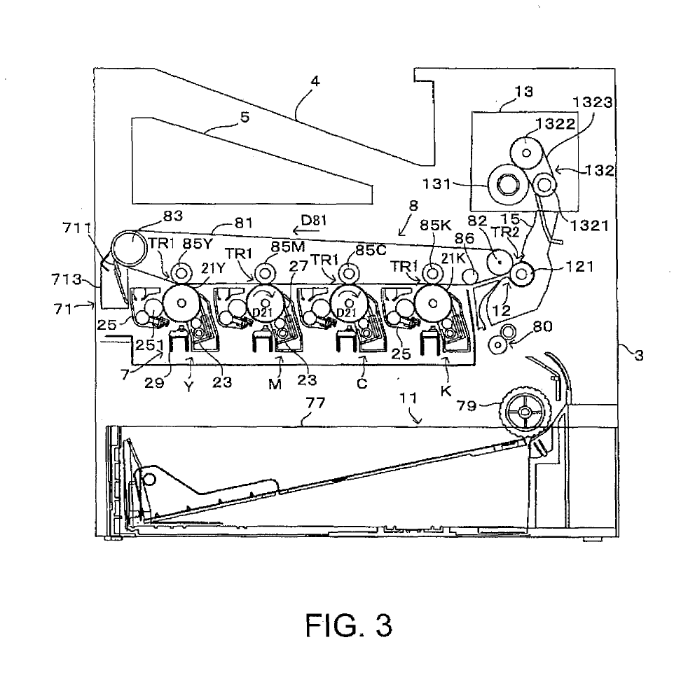

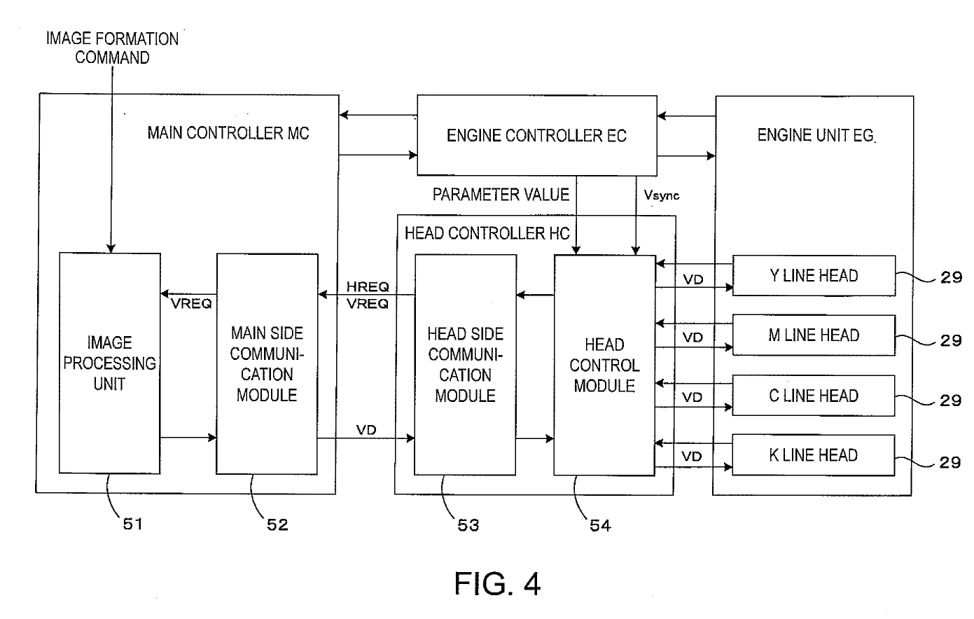

FIG. 3 is a diagram of an example of an image forming apparatus according to a first embodiment of the invention. FIG. 4 is a diagram of an electric configuration of the image forming apparatus shown in FIG. 3. The apparatus is an image forming apparatus that can selectively execute a color mode for forming a color image by superimposing toners of four colors black (K), cyan (C), magenta (M), and yellow (Y) one on top of another and a monochrome mode for forming a monochrome image using only a toner of black (K). FIG. 3 is a drawing corresponding to the execution of the color mode. In the image forming apparatus, when an image formation command is given to a main controller MC including a CPU and a memory from an external apparatus such as a host computer, the main controller MC gives a control signal or the like to an engine controller EC and gives video data VD corresponding to the image formation command to a head controller HC. The head controller HC controls line heads 29 for the respective colors on the basis of the video data VD from the main controller MC and a vertical synchronization signal Vsync and a parameter value from the engine controller EC. Consequently, an engine unit EG executes a predetermined image forming operation and forms an image corresponding to the image formation command on sheets such as copy paper, transfer paper, sheet paper, and a transparent sheet for OHP.

An electric device box 5 incorporating a power supply circuit board, the main controller MC, the engine controller EC, and the head controller HC is provided in a housing body 3 of the image forming apparatus. An image forming unit 7, a transfer belt unit 8, and a paper feeding unit 11 are also disposed in the housing body 3. In FIG. 3, a secondary transfer unit 12, a fixing unit 13, and a sheet guiding member 15 are disposed on the right side in the housing body 3. The paper feeding unit 11 is detachably attachable to an apparatus body 1. The paper feeding unit 11 and the transfer belt unit 8 can be removed and repaired or replaced.

The image forming unit 7 includes four image forming stations Y (for yellow), M (for magenta), C (for cyan), and K (for black) that form images of a plurality of different colors. In each of the image forming stations Y, M, C, and K, a cylindrical photosensitive drum 21 having a surface of predetermined length in a main scanning direction MD is provided. Each of the image forming stations Y, M, C, and K forms a toner image of the color corresponding thereto on the surface of the photosensitive drum 21. The photosensitive drum 21 is arranged such that an axial direction thereof is substantially parallel to the main scanning direction MD. The photosensitive drum 21 is connected to an exclusive driving motor and driven to rotate in a direction of an arrow D21 in the figure at predetermined speed. Consequently, the surface of the photosensitive drum 21 is conveyed in a sub-scanning direction SD orthogonal to or substantially orthogonal to the main scanning direction MD. A charging unit 23, the line head 29, a developing unit 25, and a photosensitive member cleaner 27 are disposed around the photosensitive drum 21 along a rotating direction thereof. A charging operation, a latent image forming operation, and a toner developing operation are executed by these functional units. Therefore, during the execution of the color mode, toner images formed by all the image forming stations Y, M, C, and K are superimposed on a transfer belt 81 of the transfer belt unit 8 to form a color image. During the execution of the monochrome mode, only a toner image formed by the image forming station K is used to form a monochrome image. In FIG. 3, configurations of the image forming stations of the image forming unit 7 are the same. Therefore, for convenience of illustration, reference numerals and signs are affixed to only a part of the image forming stations and are omitted for the other image forming stations.

The charging unit 23 includes a charging roller, the surface of which is made of elastic rubber. The charging roller comes into contact with the surface of the photosensitive drum 21 in a charging position and rotates following the rotation of the photosensitive drum 21. According to a rotational motion of the photosensitive drum 21, the charging roller rotates in a direction following the photosensitive drum 21 at peripheral speed. The charging roller is connected to a charging-bias generating unit (not shown). The charging roller receives the supply of a charging bias from the charging-bias generating unit and charges the surface of the photosensitive drum 21 in the charging position where the charging unit 23 and the photosensitive drum 21 come into contact with each other.

The line head 29 is arranged with respect to the photosensitive drum 21 such that a longitudinal direction of the line head 29 corresponds to the main scanning direction MD and a latitudinal direction thereof corresponds to the sub-scanning direction SD. The longitudinal direction of the line head 29 is substantially parallel to the main scanning direction MD. The line head 29 includes a plurality of light-emitting elements arranged side by side in the longitudinal direction and is arranged apart from the photosensitive drum 21. Light is irradiated from these light-emitting elements onto the surface of the photosensitive drum 21 charged by the charging unit 23. An electrostatic latent image is formed on the surface.

The developing unit 25 has, on the surface thereof, a developing roller 251 on which a toner is born. A developing bias is applied to the developing roller 251 from a developing-bias generating unit (not shown) electrically connected to the developing roller 251. A charged toner moves from the developing roller 251 to the photosensitive drum 21 in a development position where the developing roller 251 and the photosensitive drum 21 come into contact with each other. The electrostatic latent image formed by the line head 29 is visualized with the charged toner by the developing bias.

A toner image visualized in the development position in this way is carried in a rotating direction D21 of the photosensitive drum 21. Thereafter, the toner image is primarily transferred onto the transfer belt 81 in a primary transfer position TR1 where the transfer belt 81 and the respective photosensitive drums 21 come into contact with each other as explained in detail later.

In this embodiment, the photosensitive member cleaner 27 is provided in contact with the surface of the photosensitive drum 21 on a downstream side of the primary transfer position TR1 in the rotating direction D21 of the photosensitive drum 21 and an upstream side of the charging unit 23. The photosensitive member cleaner 27 comes into contact with the surface of the photosensitive drum 21 to clean and remove a toner remaining on the surface of the photosensitive drum 21 after the primary transfer.

The transfer belt unit 8 includes a driving roller 82, a driven roller 83 (a blade counter roller) disposed on the left side of the driving roller 82 in FIG. 3, and the transfer belt 81 looped around these rollers and driven to circulate in a direction of an arrow D81 shown in the figure (a conveying direction). The transfer belt unit 8 also includes, on an inner side of the transfer belt 81, four primary transfer rollers 85Y, 85M, 85C, and 85K arranged to be opposed to the respective photosensitive drums 21 of the image forming stations Y, M, C, and K in a one-to-one relation when a photosensitive cartridge is mounted. The primary transfer rollers 85 are electrically connected to a primary-transfer-bias generating unit (not shown). As explained later in detail, during the execution of the color mode, as shown in FIG. 3, all the primary transfer rollers 85Y, 85M, 85C, and 85K are positioned on the image forming stations Y, M, C, and K side. The transfer belt 81 is pressed against and brought into contact with the photosensitive drums 21 of the image forming stations Y, M, C, and K to form primary transfer positions TR1 between the photosensitive drums 21 and the transfer belt 81. A primary transfer bias is applied to the primary transfer rollers 85 from the primary-transfer-bias generating unit at appropriate timing to transfer toner images formed on the surfaces of the respective photosensitive drums 21 onto the surface of the transfer belt 81 in the primary transfer positions TR1 corresponding to the photosensitive drums 21 and form a color image.

On the other hand, during the execution of the monochrome mode, the color primary transfer rollers 85Y, 85M, and 85C among the four primary transfer rollers 85 are separated from the image forming stations Y, M, and C opposed thereto, respectively, and only the monochrome primary transfer roller 85K is brought into contact with the image forming station K. Therefore, only the monochrome image forming station K is brought into contact with the transfer belt 81. As a result, the primary transfer position TR1 is formed only between the monochrome primary transfer roller 85K and the image forming station K. A primary transfer bias is applied to the monochrome primary transfer roller 85K from the primary-transfer-bias generating unit at appropriate timing to transfer a toner image formed on the surface of the photosensitive drum 21 onto the transfer belt 81 in the primary transfer position TR1 and form a monochrome image.

Moreover, the transfer belt unit 8 includes a downstream guide roller 86 disposed on the downstream side of the monochrome primary transfer roller 85K and on the upstream side of the driving roller 82. The downstream guide roller 86 comes into contact with the transfer belt 81 on a common inscribed line between the primary transfer roller 85K and the photosensitive drum 21 in the primary transfer position TR1 where the monochrome primary transfer roller 85K comes into contact with the photosensitive drum 21 of the image forming station K to form a monochrome image.

The driving roller 82 drives to circulate the transfer belt 81 in the direction of the arrow D81 shown in the figure and also serves as a backup roller for a secondary transfer roller 121. A rubber layer having the thickness of about 3 mm and volume resistivity equal to or lower than 1000 kΩ·cm is formed on the circumferential surface of the driving roller 82. The driving roller 82 is grounded via a metal shaft to form a conductive path for a secondary transfer bias supplied from a not-shown secondary-transfer-bias generating unit via the secondary transfer roller 121. The rubber layer having high friction and shock absorbing properties is provided in the driving roller 82 in this way. Consequently, shock caused when a sheet enters a contact portion of the driving roller 82 and the secondary transfer roller 21 (a secondary transfer position TR2) is less easily transmitted to the transfer belt 81. It is possible to prevent deterioration in an image quality.

The paper feeding unit 11 includes a paper feeding unit having a paper feeding cassette 77 in which sheets can be stacked and stored and a pickup roller 79 that feeds the sheets one by one from the paper feeding cassette 77. After paper feeding timing is adjusted by a registration roller pair 80, the sheet fed from the paper feeding unit by the pickup roller 79 is fed to the secondary transfer position TR2 along the sheet guiding member 15.

The secondary transfer roller 121 is provided to freely come into contact with and separate from the transfer belt 81 and is driven by a secondary-transfer-roller driving mechanism (not shown) to come into contact with and separate from the transfer belt 81. The fixing unit 13 has a heating roller 131 that incorporates a heating element such as a halogen heater and can freely rotate and a pressing unit 132 that presses and urges the heating roller 131. A sheet having an image secondarily transferred on the surface thereof is guided to a nip section, which is formed by the heating roller 131 and a pressing belt 1323 of the pressing unit 132, by a sheet guiding member 15. The image is thermally fixed in the nip section at predetermined temperature. The pressing unit 132 includes two rollers 1321 and 1322 and a pressing belt 1323 looped around these rollers. A belt stretched surface stretched by the two rollers 1321 and 1322 of the surface of the pressing belt 1323 is pressed against the circumferential surface of the heating roller 131 to secure the nip section formed by the heating roller 131 and the pressing belt 1323 wide. The sheet subjected to the fixing processing is conveyed to a paper discharge tray 4 provided in an upper surface section of the housing body 3.

In this apparatus, a cleaner unit 71 is disposed to be opposed to the blade counter roller 83. The cleaner unit 71 has a cleaner blade 711 and a waste toner box 713. The cleaner blade 711 brings a tip thereof into contact with the blade counter roller 83 via the transfer belt 81 to remove foreign matters such as a toner and paper powder remaining on the transfer belt after the secondary transfer. The foreign matters removed in this way are collected in the waste toner box 713. The cleaner blade 711 and the waste toner box 713 are formed integrally with the blade counter roller 83. Therefore, as explained below, when the blade counter roller 83 moves, the cleaner blade 711 and the waste toner box 713 also move together with the blade counter roller 83.

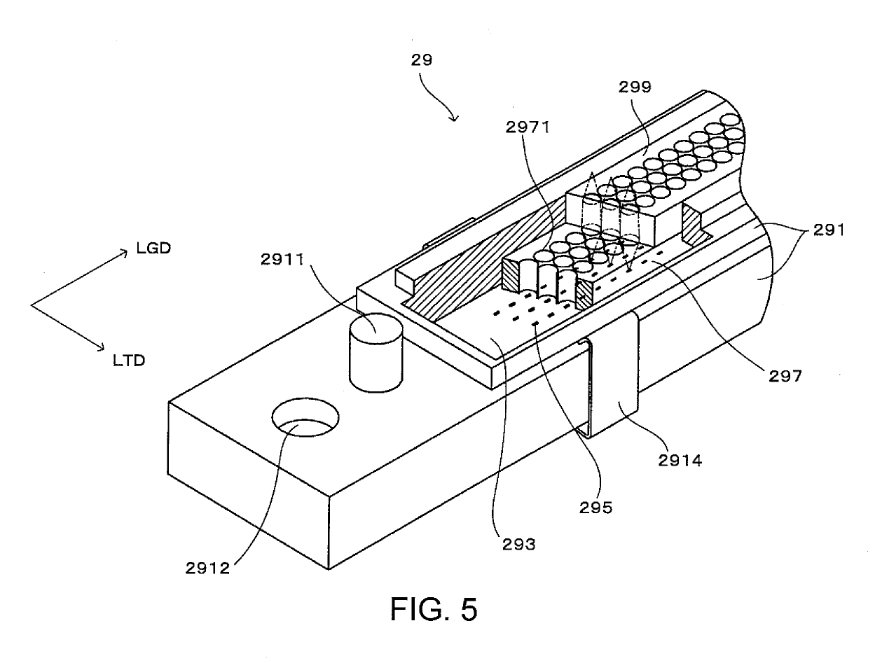

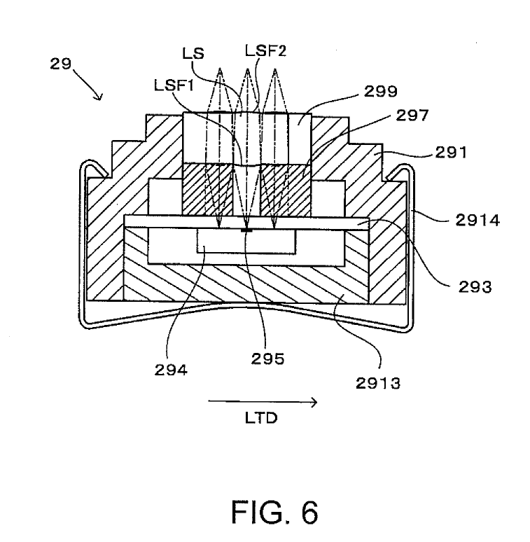

FIG. 5 is a schematic perspective view of a line head according to this embodiment. FIG. 6 is a sectional view in a latitudinal direction of the line head shown in FIG. 5. As explained above, the line head 29 is arranged with respect to the photosensitive drum 21 such that the longitudinal direction LGD thereof corresponds to the main scanning direction MD and the latitudinal direction LTD corresponds to the sub-scanning direction SD. The longitudinal direction LGD and the latitudinal direction LTD are substantially orthogonal to each other. The line head 29 includes a case 291. A positioning pin 2911 and a screw inserting hole 2912 are provided at both ends in the longitudinal direction LGD of the case 291. The line head 29 is positioned with respect to the photosensitive drum 21 by fitting the positioning pin 2911 into a positioning hole (not shown) drilled in a photosensitive member cover (not shown) that covers the photosensitive drum 21 and is positioned with respect to the photosensitive drum 21. Further, the line head 29 is positioned and fixed with respect to the photosensitive drum 21 by screwing a fixing screw into a screw hole (not shown) of the photosensitive member cover via the screw inserting hole 2912 and fixing the fixing screw.

The case 291 holds the lens array 299 in a position opposed to the surface of the photosensitive drum 21. The case 291 includes a light blocking member 297 and the head substrate 293 close to the lens array 299 in this order. The head substrate 293 is formed of a material (e.g., glass) that can transmit a light beam. A plurality of organic EL (Electro-Luminescence) elements of a bottom emission type are arranged on a rear surface of the head substrate 293 (a surface on the opposite side of the lens array 299 of two surfaces of the head substrate 293) as the light-emitting elements 2951. As explained later, the plurality of light-emitting elements 2951 are arranged to be grouped for each of the light-emitting element groups 295. Light beams emitted from the light-emitting element groups 295 are transmitted from the rear surface to the front surface of the head substrate 293 and travel to the light blocking member 297.

A plurality of light guiding holes 2971 are drilled in the light blocking member 297 in a one-to-one relation with respect to the plurality of light-emitting element groups 295. The light guiding holes 2971 are drilled as substantially columnar holes that pierce through the light blocking member 297 with a line parallel to the normal of the head substrate 293 set as a center axis. Therefore, among light beams emitted from the light-emitting element groups 295, light beams traveling to places other than the light guiding holes 2971 corresponding to the light-emitting element groups 295 are blocked by the light blocking member 297. In this way, all light beams emitted from one of the light-emitting element groups 295 travel to the lens array 299 via the same light guiding hole 2971. Interference of light beams emitted from the different light-emitting element groups 295 is prevented by the light blocking member 297. Light beams passing through the light guiding hole 2971 drilled in the light blocking member 297 are focused on the surface of the photosensitive drum 21 as spots by the lens array 299.

As shown in FIG. 6, a rear lid 2913 is pressed against the case 291 by a fixing fitting 2914 via the head substrate 293. The fixing fitting 2914 has elastic force for pressing the rear lid 2913 to the case 291 side. The fixing fitting 2914 presses the rear lid with such elastic force to seal the inside of the case 291 in a light-tight manner (i.e., prevent light from leaking from the inside of the case 291 and prevent light from entering the case 291 from the outside). A plurality of the fixing fittings 2914 are provided in a longitudinal direction of the case 291. The light-emitting element group 295 is covered by a sealing member 294.

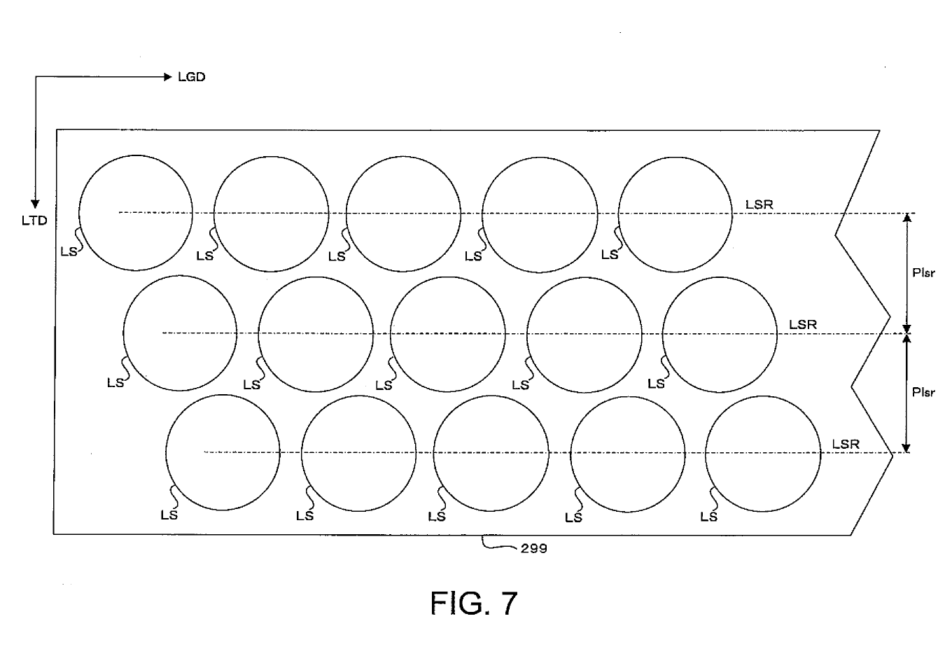

FIG. 7 is a schematic plan view of a lens array. The lens array is viewed from an image plane side (the photosensitive drum 21 surface side). As shown in the figure, in this lens array 299, the plurality of lenses LS are arranged along the longitudinal direction LGD to form the lens row LSR. A trio of the lens rows LSR are arranged in the latitudinal direction LTD at the lens row pitches Plsr. The three lens rows LSR1 to LSR3 are shifted from one another in the longitudinal direction LGD such that positions of the lenses LS are different from one another in the longitudinal direction LGD. As a result, the positions of the lenses LS are different from one another in the longitudinal direction LGD.

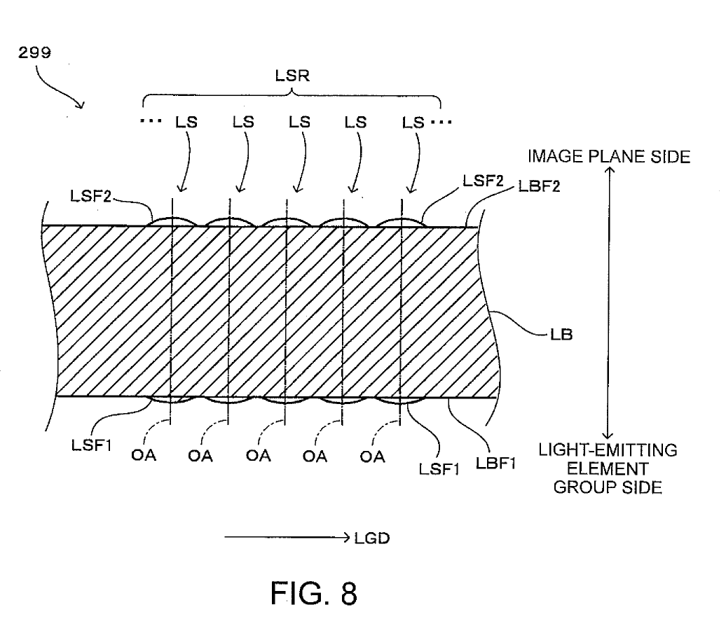

FIG. 8 is a sectional view in the longitudinal direction of the lens array. The lens array is viewed in a section including optical axes OA of lenses. In the figure, an upper side is the image plane side and a lower side is the light-emitting element group side. In the lens array 299, one lens substrate LB formed of glass is provided. The lens LS is formed by two lens surfaces LSF1 and LSF2 arranged in an optical axis OA direction to hold the lens substrate LB. The lens surfaces LSF1 and LSF2 can be formed of, for example, photo-curing resin. The lens surface LSF1 of the two lens surfaces is formed on a rear surface LBF1 of the lens substrate LB. The lens surface LSF2 is formed on a front surface LBF2 of the lens substrate LB. The plurality of lenses LS are arranged in the longitudinal direction LGD to form the lens row LSR.

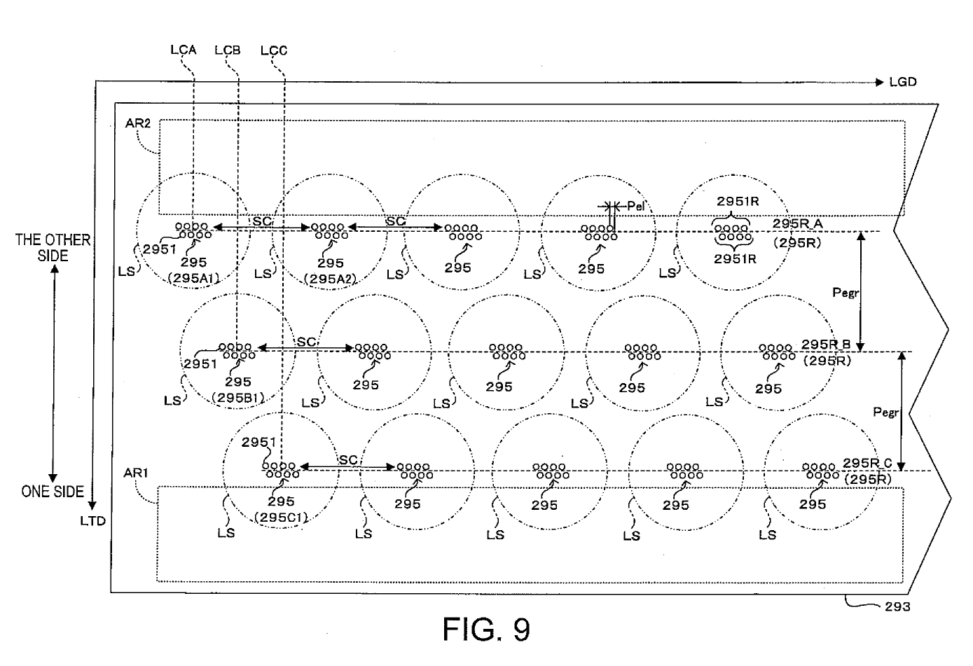

FIG. 9 is a diagram of a configuration of a rear surface of a head substrate. The rear surface is viewed from the front surface of the head substrate. In FIG. 9, the lenses LS are indicated by alternate long and two short dashes lines. However, this indicates the light-emitting element groups 295 are provided in a one-to-one relation with respect to the lenses LS and does not indicate that the lenses LS are arranged on the rear surface of the head substrate. A trio of the light-emitting element group rows 295R (295R_A, 295R_B, and 295R_C), in which the plurality of light-emitting element groups 295 are arranged along the longitudinal direction LGD, are arranged in the latitudinal direction LTD at the light-emitting element group row pitches Pegr. In each of the light-emitting element group rows 295R_A to 295R_C, the plurality of light-emitting element groups 295 are arranged at intervals of space SC. The light-emitting element group rows 29SR are shifted from one another in the longitudinal direction LGD. Positions of the light-emitting element groups 295 are different from one another in the longitudinal direction LGD. Specifically, positions LCA, LCB, and LCC in the longitudinal direction LGD of light-emitting element groups 295A1, 295B1, and 295C1 are different from one another. In the figure, the positions LCA, LCB, and LCC are represented by feet of perpendiculars drawn from center of gravity positions of the light-emitting element groups 295A1, 295B1, and 295C1 to a longitudinal direction LGD axis.

In this way, the light-emitting element group rows 295R are arranged to be shifted from one another in the longitudinal direction LGD. Therefore, each of the light-emitting element groups 295 is opposed to the spaces SC of the light-emitting element group rows 295R, to which the light-emitting element group 295 does not belong, in the latitudinal direction LTD. Specifically, for example, the light-emitting group 295A2 is opposed to the spaces SC of the light-emitting element group rows 295R_B and 295R_C in the latitudinal direction LTD.

For later explanation, an area located further on one side in the latitudinal direction LTD than the plurality of light-emitting element groups 295 arranged in this way is referred to as one area AR1. An area located on the opposite side of the one area across the plurality of light-emitting element groups 295 in the latitudinal direction LTD (in other words, an area located further on the other side in the latitudinal direction LTD than the plurality of light-emitting element groups 295) is referred to as the other area AR2. The one area AR1 and the other area AR2 are areas on the rear surface of the head substrate 293, i.e., the surface on which the light-emitting elements 2951 are formed.

In each of the light-emitting element groups 295, the light-emitting element rows 2951R, in each of which a quartet of the light-emitting elements 2951 are arranged in the longitudinal direction LGD, are arranged side by side in the latitudinal direction LTD. The light-emitting element rows 2951R are arranged to be shifted the light-emitting element pitches Pel in the longitudinal direction LGD. Positions of the light-emitting elements 2951 are different from one another in the longitudinal direction LGD. In this way, in the light-emitting element group 295, the light-emitting element rows 2951R in the two columns are arranged in a zigzag.

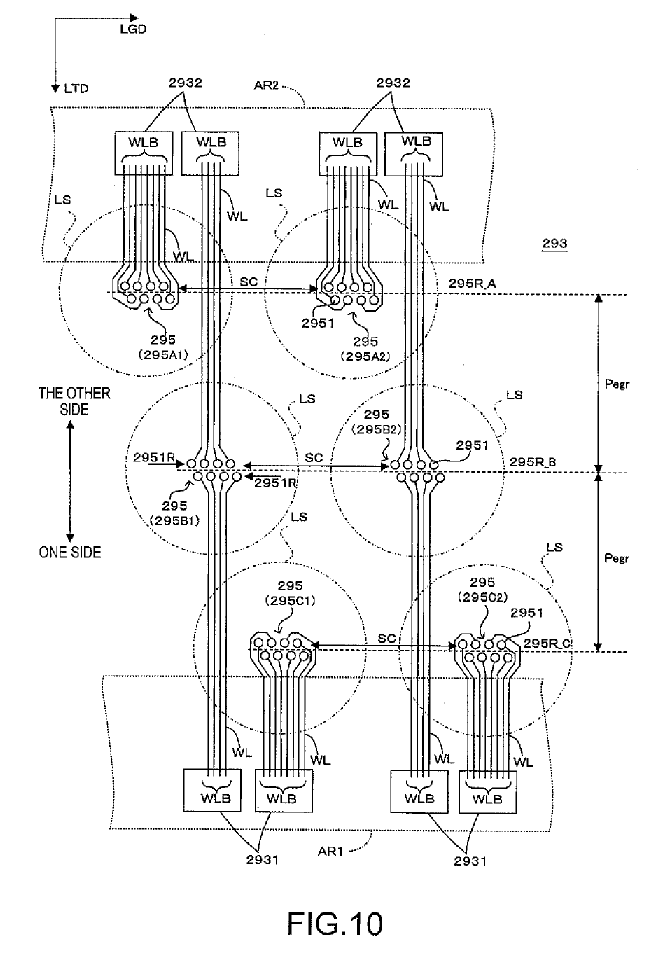

FIG. 10 is a plan view of a form of connection of wiring lines to the light-emitting element groups according to the first embodiment. As shown in the figure, a plurality of wiring lines WL are respectively connected to the plurality of light-emitting elements 2951 of the light-emitting element groups 295. In this way, the plurality of wiring lines WL connected to the light-emitting element groups 295 are bound as wiring line bundles WLB. The wiring line bundles WLB are drawn out to the outside of the lenses LS. In the first embodiment, all the wiring lines WL (or the wiring line bundles WLB) drawn out from the light-emitting element group row 295R_A at an end on the other side in the latitudinal direction LTD are drawn out to the other area AR2 of the head substrate 293. On the other hand, all the wiring lines WL (or the wiring line bundles WLB) drawn out from the light-emitting element group row 295R_C at an end on one side in the latitudinal direction LTD are drawn out to the one area AR1 of the head substrate 293. The wiring lines WL drawn out from the light-emitting element group row 295R_B in the center in the latitudinal direction LTD are drawn out to both the one area AR1 and the other area AR2. In other words, in the light-emitting element groups 295 in the light-emitting element group row 295R_B, the two light-emitting element rows 2951R are arranged in the latitudinal direction LTD. The wiring lines WL (or the wiring line bundle WLB) connected to the light-emitting element rows 2951R on one side of the two light-emitting element rows 2951R are drawn out to the one area AR1. The wiring lines WL (or the wiring line bundle WLB) connected to the light-emitting element rows 2951R on the other side are drawn out to the other area AR2. In this way, in the first embodiment, the wiring lines WL are allotted at the light-emitting element group row 295R_B in the latitudinal direction LTD and drawn out to both the sides in the latitudinal direction LTD.

In other words, on the head substrate 293, the three light-emitting element group rows, i.e., the light-emitting element group row 295R_C, the light-emitting element group row 295R_B, and the light-emitting element group row 295R_A are disposed from one side to the other side in the latitudinal direction LTD. First connecting units 2931 are provided in the one area AR1 and second connecting units 2932 are provided in the other area AR2. The wiring lines WL electrically connected to the light-emitting elements 2951 belonging to the light-emitting element group 295C1 and the light-emitting element group 295C2 on one side in the latitudinal direction LTD are electrically connected to the first connecting units 2931. The wiring lines WL electrically connected to the light-emitting elements 2951 belonging to the light-emitting element group 295A and the light-emitting element group 295A2 on the other side in the latitudinal direction LTD are electrically connected to the second connecting units 2932. The wiring lines WL electrically connected to the light-emitting elements 2951 belonging to the light-emitting element rows 2951R on one side among the light-emitting elements 2951 belonging to the light-emitting element group 295B1 and the light-emitting element group 295B2 in the center in the latitudinal direction LTD are electrically connected to the first connecting units 2931. On the other hand, the wiring lines WL electrically connected to the light-emitting elements 2951 belonging to the light-emitting element rows 2951R on the other side are electrically connected to the second connecting units 2932.

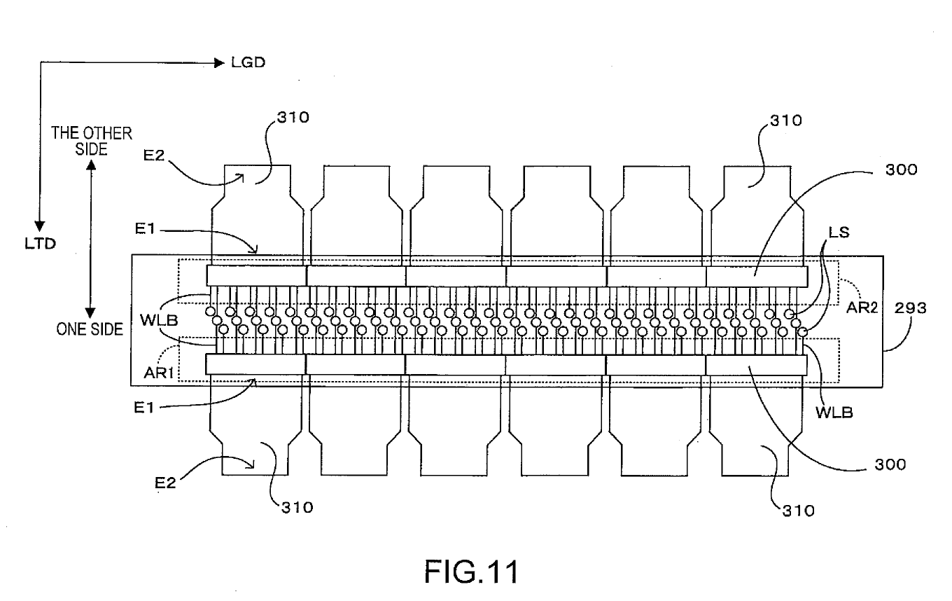

FIG. 11 is a diagram of an arrangement relation between wiring line bundles and driver ICs according to the first embodiment. In the figure, only the wiring line bundles WLB drawn out to the outside of the lenses LS are shown. Details of the wiring lines WL connected to the light-emitting elements 2951 of the light-emitting element groups 295 are not shown because the details are the same as those shown in FIG. 10. As shown in FIG. 11, a plurality of driver ICs (electric circuits) 300 are arranged in the longitudinal direction LGD in each of the one area AR1 and the other area AR2 of the head substrate 293. The driver ICs 300 can be mounted on the substrate 293 including glass as a base material by a so-called chip-on-glass technique. In each of the one area AR1 and the other area AR2, the wiring line bundles WLB drawn out to the area AR1 or AR2 are connected to the driver ICs 300. In other words, the driver ICs 300 on one side are electrically connected to the first connecting units 2931 (see FIG. 10) provided in the one area AR1 and electrically connected to the wiring line bundles WLB via the first connecting units 2931. The driver ICs 300 on the other side are electrically connected to the second connecting units 2932 (see FIG. 10) provided in the other area AR2 and electrically connected to the wiring line bundles WLB via the second connecting units 2932. A plurality of FPCs 310 are provided in the longitudinal direction LGD in each of the one area AR1 and the other area AR2. One ends E1 of the FPCs 310 are attached to the areas AR1 and AR2. The one ends E1 are connected to the driver ICs 300. Attachment of the FPCs 310 to the head substrate 293 can be performed by, for example, an anisotropic conductive film (ACF).

The other ends E2 of the FPCs 310 are drawn out to the outside of the head substrate 293. Video data VD outputted from the head controller HC can be inputted to the other ends E2. Therefore, when the head controller HC outputs video data VD at appropriate timing (see FIG. 2), the video data VD is inputted to the other ends E2 of the FPCs 310. The video data VD inputted to the other ends E2 of the FPCs 310 is inputted to the driver ICs 300 connected to the one ends E1 of the FPCs 310. The driver ICs 300 covert the video data VD into driving signals for driving the light-emitting elements 2951. The driving signals are given to the light-emitting elements 2951 via the wiring lines WL. The light-emitting elements 2951, to which the driving signals are given, emit light beams having wavelengths equal to one another. Light-emitting surfaces of the light-emitting elements 2951 are so-called perfect diffuser light sources. Light beams emitted from the light-emitting surfaces comply with the Lambert's cosine law.

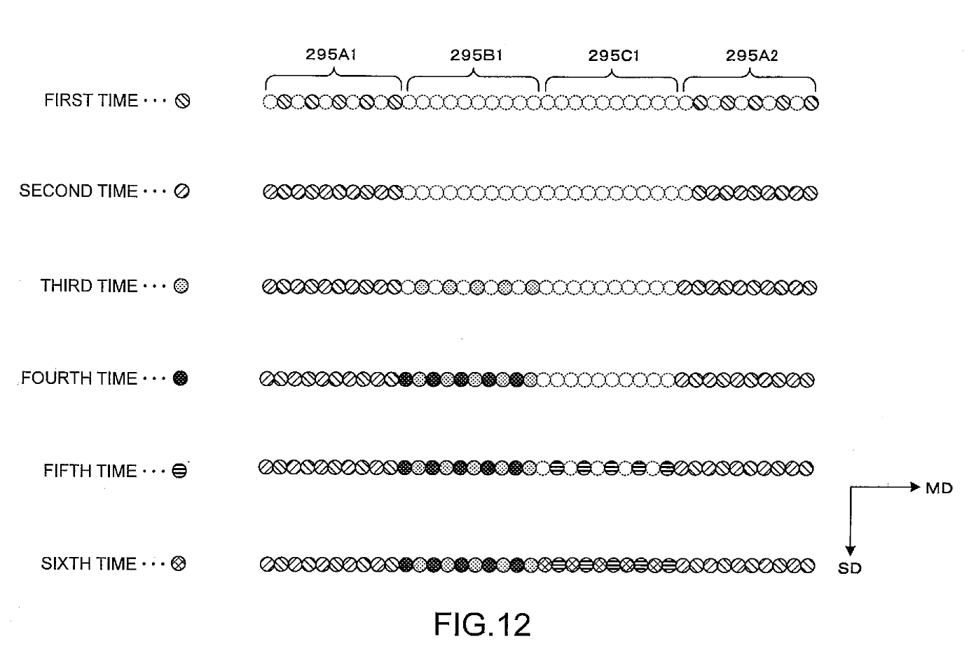

FIG. 12 is a diagram of a spot forming operation in the line head explained above. The spot forming operation by the line head according to this embodiment is explained with reference to FIG. 12. To facilitate understanding of the invention, a plurality of spots are arranged in a linear shape extending in the main scanning direction MD to form a line latent image. Briefly, in such a latent image forming operation, a plurality of light-emitting elements are caused to emit light at predetermined timing according to the video data VD outputted from the head controller HC while the surface of the photosensitive drum 21 is conveyed in the sub-scanning direction SD (the latitudinal direction LTD). Consequently, a plurality of spots are formed side by side in a linear shape extending in the main scanning direction MD (the longitudinal direction LGD). Details of the spot forming operation are explained below.

First, the light-emitting element rows 2951R on the downstream side in the latitudinal direction LTD among the light-emitting element rows 2951R belonging to the light-emitting element groups 295A1, 295A2, and the like most upstream in the latitudinal direction LTD are caused to emit light. A plurality of light beams emitted by such a light emitting operation are focused on the surface of the photosensitive drum by the lenses LS. In this embodiment, the lenses LS have inversion properties. The light beams from the light-emitting elements 2951 are focused in an inverted form. In this way, spots are formed in positions of hatching patterns in a “first time” shown in FIG. 12. In the figure, white circles represent spots not formed yet and expected to be formed later. In the figure, spots denoted by reference signs 295C1, 295B1, 295A1, and 295C2 are spots formed by the light-emitting element groups 295 corresponding to the reference signs.

Subsequently, the light-emitting element rows 2951R on the upstream side in the latitudinal direction LTD among the light-emitting element rows 2951R belonging to the light-emitting element groups 295A1, 295A2, and the like are caused to emit light. A plurality of light beams emitted by such a light emitting operation are focused on the surface of the photosensitive drum by the lenses LS. In this way, spots are formed in positions of hatching patterns in a “second time” shown in FIG. 12. As explained above, the light-emitting element rows 2951R on the downstream side in the latitudinal direction LTD are caused to emit light first in order to cope with the inversion properties of the lenses LS.

The light-emitting element rows 2951R on the downstream side in the latitudinal direction LTD among the light-emitting element rows 2951R belonging to the light-emitting element groups 295B1 and the like second from the upstream side in the latitudinal direction LTD are caused to emit light. A plurality of light beams emitted by such a light emitting operation are focused on the surface of the photosensitive drum by the lenses LS. In this way, spots are formed in positions of hatching patterns in a “third time” shown in FIG. 12.

The light-emitting element rows 2951R on the upstream side in the latitudinal direction LTD among the light-emitting element rows 2951R belonging to the light-emitting element groups 295B1 and the like second from the upstream side in the latitudinal direction LTD are caused to emit light. A plurality of light beams emitted by such a light emitting operation are focused on the surface of the photosensitive drum by the lenses LS. In this way, spots are formed in positions of hatching patterns in a “fourth time” shown in FIG. 12.

The light-emitting element rows 2951R on the downstream side in the latitudinal direction LTD among the light-emitting element rows 2951R belonging to the light-emitting element groups 295C1 and the like third from upstream side in the latitudinal direction LTD are caused to emit light. A plurality of light beams emitted by such a light emitting operation are focused on the surface of the photosensitive drum by the lenses LS. In this way, spots are formed in positions of hatching patterns in a “fifth time” shown in FIG. 12.

Finally, the light-emitting element rows 2951R on the upstream side in the latitudinal direction LTD among the light-emitting element rows 2951R belonging to the light-emitting element groups 295C1 and the like third from the upstream side in the latitudinal direction LTD are caused to emit light. A plurality of light beams emitted by such a light emitting operation are focused on the surface of the photosensitive drum by the lenses LS. In this way, spots are formed in positions of hatching patterns in a “sixth time” shown in FIG. 12. A plurality of spots are formed side by side in a linear shape extending in the longitudinal direction LGD (the main scanning direction MD) by executing the first to sixth light emitting operations in this way.

As explained above, the FPCs 310 are provided on both the sides in the latitudinal direction LTD of the head substrate 293. Therefore, the wiring lines WL connected to the light-emitting elements 2951 can be drawn out in any direction of the head substrate 293 in the latitudinal direction LTD. A degree of freedom of the wiring lines WL connected to the light-emitting elements 2951 is improved.

In other words, in the first embodiment, on the head substrate 293, the light-emitting element group row 295R_C (corresponding to the “first light-emitting element group row” of the invention) and the light-emitting element group row 295R_B and the light-emitting element group row 295R_A (corresponding to the “Nth light-emitting element group row” of the invention) are disposed from one side to the other side in the latitudinal direction LTD. The first connecting sections 2931 are provided in the one area AR1 and the second connecting units 2932 are provided in the other area AR2. The wiring lines WL electrically connected to the light-emitting elements 2951 belonging to the light-emitting element groups 295C1 and 295C2 included in the light-emitting element group row 295R_C are electrically connected to the first connecting units 2931. The wiring lines WL electrically connected to the light-emitting elements 2951 belonging to the light-emitting element groups 295A1 and 295A2 included in the light-emitting element group row 295R_A are electrically connected to the second connecting units 2932. Therefore, it is possible to reduce the length of the wiring lines and realize simplification of design of the wiring lines.

In the line head 29 according to the first embodiment, a problem peculiar to the line head 29, which does not occur in the related art, may occur. In the line head 29, the light-emitting element group rows 295R area arranged side by side in the latitudinal direction LTD. As a result, the length of the wiring lines WL connected to the light-emitting element group rows 295R may be different among the light-emitting element group rows 295R. When the length of the wiring lines WL fluctuates, the wiring line resistance of the wiring lines WL fluctuates among the light-emitting element group rows 295R. As a result, driving currents (driving signals) supplied to the light-emitting elements 2951 may be different depending on the light-emitting element group rows 295R. Therefore, the problem peculiar to the line head 29 according to this embodiment is explained below through comparison with the related art that uses the graded index rod lens array.

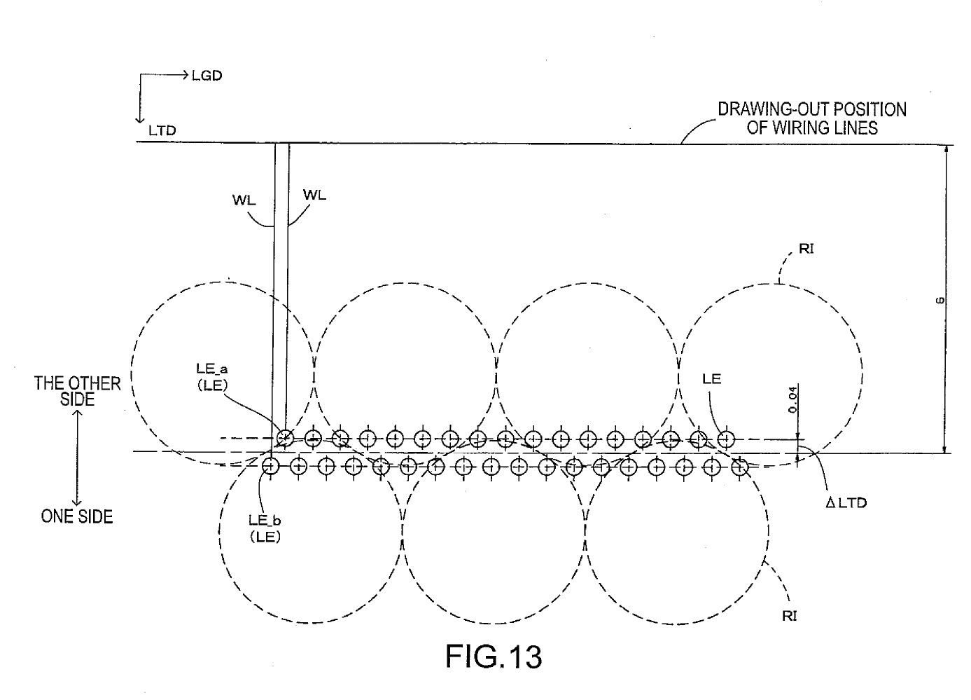

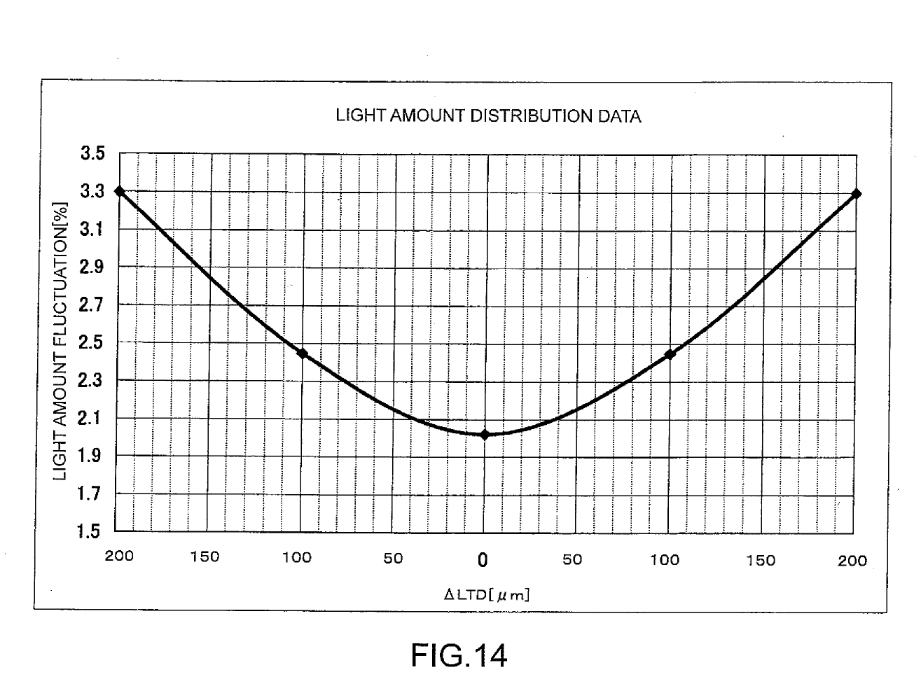

FIG. 13 is a schematic diagram of a configuration of a line head in the past. FIG. 14 is a diagram of a light amount of a spot formed by the line head shown in FIG. 13. In the line head shown in FIG. 13, a plurality of light-emitting elements LE are arranged in a zigzag in two rows. A rod lens array formed by stacking a plurality of graded index rod lenses RI in a zigzag is arranged to be opposed to the light-emitting elements LE. Light beams emitted from the light-emitting elements LE are focused as erect and unmagnified spots by the rod lens array. In the line head using such a rod lens array, when the light-emitting elements LE deviate from a center position CP of the rod lens array in the latitudinal direction LTD, a light amount of spots formed by the light-emitting elements LE fluctuates. Such fluctuation in a light amount is desirably limited to within about 2%. Therefore, the light-emitting elements LE need to be arranged within 40 μm from the center position CP in the latitudinal direction LTD (see FIG. 13). Therefore, as shown in FIG. 14, a distance ALTD between the light-emitting elements LE arranged in different positions in the latitudinal direction LTD is set to 40 μm×2=80 μm.

It is assumed that, in the line head shown in FIG. 13 and the like, the wiring lines WL are drawn out to only the other side in the latitudinal direction LTD from the light-emitting elements LE. For example, when the wiring lines WL are drawn out from the light-emitting elements LE to a “drawing-out position of wiring lines” shown in the figure, a difference between the wiring length (6 mm−40 μm) of the wiring line WL connected to a light-emitting element LE_a and the wiring length (6 mm+40 μm) of the wiring line WL connected to a light-emitting element LE_b is about 1.3%. Therefore, in the line head shown in FIG. 13, fluctuation in a driving current due to fluctuation in wiring resistance among the light-emitting elements LE does not pose a problem.

On the other hand, in the line head 29 according to this embodiment, the light-emitting element group row pitch Pegr is in a millimeter order (see FIGS. 9 and 10). Since the lenses LS opposed to the light-emitting element groups 295 have a diameter of about several millimeters in order to capture light beams having a sufficient light amount, the lens row pitches Plsr of the lens rows LSR arranged in the latitudinal direction LTD is about several millimeters. Therefore, the light-emitting element group row pitch Pegr of the light-emitting element group rows 29SR arranged to be opposed to the lens rows LSR also needs to be about several millimeters. Therefore, when the wiring lines WL are drawn out to only the other side in the latitudinal direction LTD from the light-emitting elements 2951, the wiring lengths of the wiring lines WL is substantially different among the light-emitting element group rows 295R. As a result, supplied driving currents (driving signals) may be substantially different.

On the other hand, in the first embodiment, as explained with reference to FIG. 10, the wiring lines WL are distributed and drawn out to both the sides in the latitudinal direction LTD. Therefore, compared with the wiring lines WL drawn out to only the other side in the latitudinal direction LTD from the light-emitting elements 2951, it is possible to suppress fluctuation in the wiring length among the light-emitting element group rows 295R and suppress fluctuation in a supplied driving current.

In the first,embodiment, the driver ICs 300 are provided on the head substrate 293. Therefore, in the first embodiment, the driver ICs 300 can be arranged relatively closer to the light-emitting elements 2951. Therefore, it is possible to supply driving signals with little dullness due to stray capacitance and the like to the light-emitting elements 2951.

In the first embodiment, the three light-emitting element group rows 295R are arranged side by side in the latitudinal direction LTD (corresponding to “N=3” of the invention). In each of the light-emitting element groups 205, the two light-emitting element rows 2951R, in which the four light-emitting elements 2951 in the longitudinal direction LGD, are arranged in the latitudinal direction LTD. However, the number of the light-emitting element group rows 295R and the configuration of the light-emitting element groups 295 are not limited to those in the first embodiment and, for example, can be changed as explained below.

### C. Second Embodiment

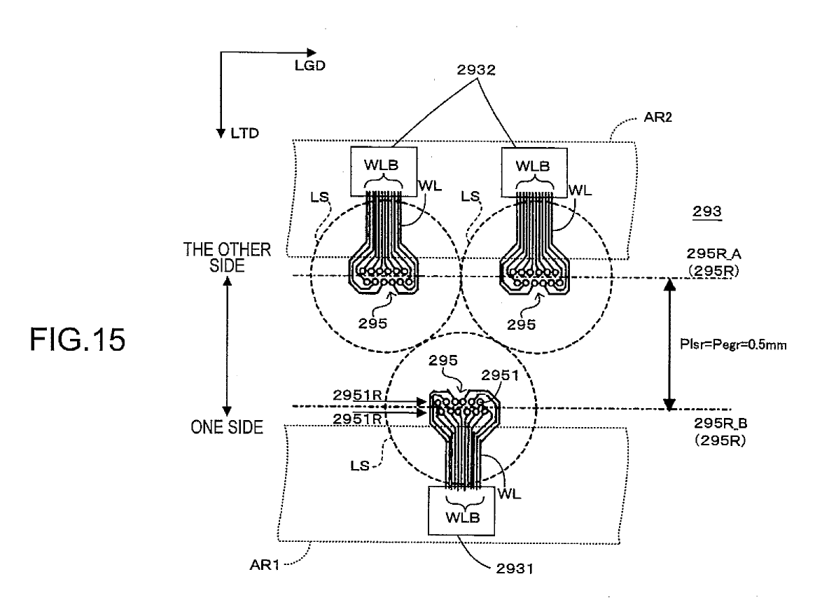

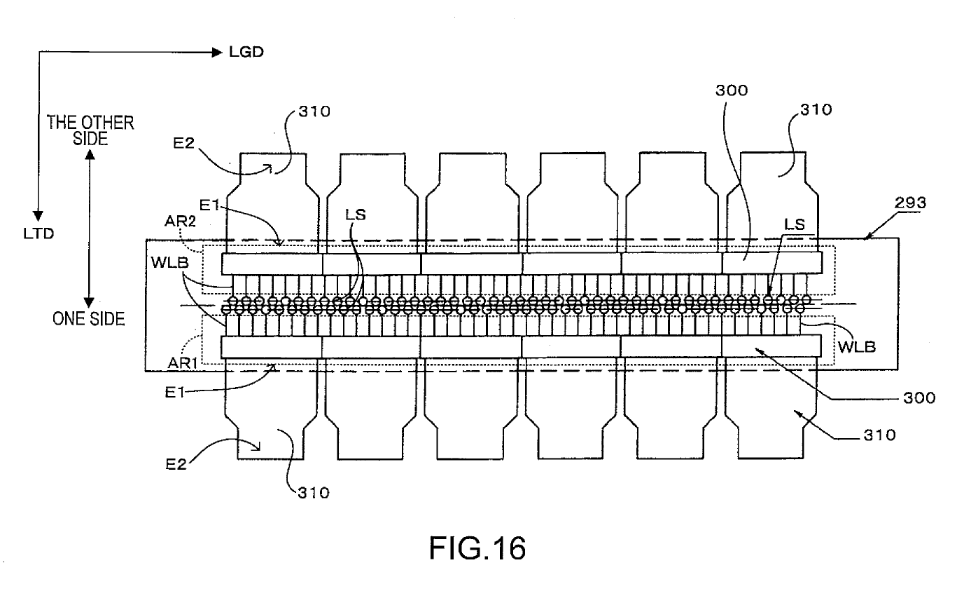

FIG. 15 is a plan view of a form of connection of wiring lines to light-emitting element groups according to a second embodiment of the invention. FIG. 16 is a diagram of an arrangement relation between wiring line bundles and driver ICs according to the second embodiment. Differences from the first embodiment are mainly explained below. Components same as those in the first embodiment are denoted by the same reference numerals and signs and explanation of the components is omitted. As shown in FIG. 15, in the second embodiment, the two light-emitting element group rows 295R (295R_A and 295R_B) are arranged side by side in the latitudinal direction LTD. In each of the light-emitting element groups 295, the two light-emitting element rows 2951R, in which a sextet of the light-emitting elements 2951 are arranged in the longitudinal direction LGD, are arranged in the latitudinal direction LTD (see FIG. 15). The light-emitting element rows 2951R are arranged to be shifted from one another in the longitudinal direction LGD. As a result, positions of the light-emitting elements 2951 are different from one another in the longitudinal direction LGD. The wiring lines WL connected to the light-emitting element groups 295 of the light-emitting element group row 295R_A are drawn out to the other area AR2. The wiring lines WL connected to the light-emitting element groups 295 of the light-emitting element group row 295R_B are drawn out to the one area AR1.

The lens LS is arranged to be opposed to each of the light-emitting element groups 295 (see FIGS. 15 and 16). A light beam emitted from the light-emitting element group 295 is focused by the lens LS. In the second embodiment, a diameter of the lens LS is about 0.57 mm. The plurality of lenses LS are arranged in a zigzag to be set in contact with one another. As a result, the lens row pitch Plsr and the light-emitting element group row pitch Pegr are about 0.5 mm.

As shown in FIG. 16, the plurality of driver ICs (electric circuit) 300 are arranged in the longitudinal direction LGD in each of the one area AR1 and the other area AR2 of the head substrate 293. In each of the one area AR1 and the other area AR2, the wiring line bundles WLB drawn out to the area AR1 or AR2 are connected to the driver ICs 300. Moreover, in each of the one area AR1 and the other area AR2, the plurality of FPCs 310 are provided in the longitudinal direction LGD. The one ends E1 of the FPCs 310 are attached to the areas AR1 and AR2.

As explained above, in the second embodiment, as in the first embodiment, the FPCs 310 are provided on both the sides in the latitudinal direction LTD of the head substrate 293. Therefore, the wiring lines WL connected to the light-emitting elements 2951 can be drawn out to any direction of the head substrate 293 in the latitudinal direction LTD as well. A degree of freedom of the wiring lines WL connected to the light-emitting elements 2951 is improved.

In other words, in the second embodiment, on the head substrate 293, the light-emitting element group row 295R_B (corresponding to the “first light-emitting element group row” of the invention) and the light-emitting element group row 295R_A (corresponding to the “Nth light-emitting element group row” of the invention) are disposed from one side to the other side in the latitudinal direction LTD. The first connecting sections 2931 are provided in the one area AR1 and the second connecting units 2932 are provided in the other area AR2. The wiring lines WL electrically connected to the light-emitting elements 2951 belonging to the light-emitting element groups 295 included in the light-emitting element group row 295R_B are electrically connected to the first connecting units 2931. The wiring lines WL electrically connected to the light-emitting elements 2951 belonging to the light-emitting element groups 295 included in the light-emitting element group row 295R_A are electrically connected to the second connecting units 2932. Therefore, it is possible to reduce the length of the wiring lines and realize simplification of design of the wiring lines.

In the second embodiment, as explained with reference to FIG. 15, the wiring lines WL connected to the light-emitting element groups 295 of the light-emitting element group row 295R_A are drawn out to the other area AR2. The wiring lines WL connected to the light-emitting element groups 295 of the light-emitting element group row 295R_B are drawn out to the one area AR1. Therefore, compared with the wiring lines WL drawn out to only the other side in the latitudinal direction LTD from the light-emitting elements 2951, it is possible to suppress fluctuation in the wiring length among the light-emitting element group rows 295R and suppress fluctuation in a supplied driving current.

In the first and second embodiments, the driver ICs 300 are provided on the head substrate 293. However, an arrangement position of the driver ICs 300 is not limited to this and can be changed as explained below.

### D. Third Embodiment

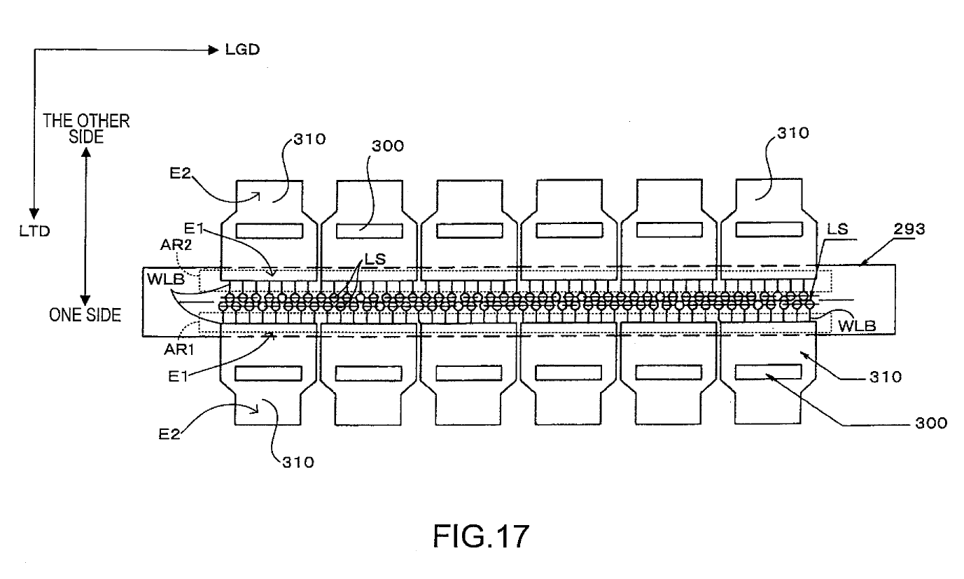

FIG. 17 is a diagram of an arrangement relation between wiring line bundles and driver ICs according to the third embodiment. Differences from the first and second embodiments are mainly explained below. Components same as those in the first and second embodiments are denoted by the same reference numerals and signs and explanation of the components is omitted. As shown in FIG. 17, the plurality of FPCs 310 are provided in the longitudinal direction LGD in each of the one area AR1 and the other area AR2 of the head substrate 293. The one ends E1 of the FPCs 310 are attached to the areas AR1 and AR2. In each of the one area AR1 and the other area AR2, the wiring line bundles WLB drawn out to the area AR1 or AR2 are connected to the one ends E1 of the FPCs 310. In the third embodiment, the driver ICs 300 are provided between the one ends E1 and the other ends E2 of the FPCS 310 rather than on the head substrate 293. The driver ICs 300 are mounted on the FPCs 310 by a so-called chip-on-film technique.

Therefore, when the head controller HC outputs video data VD at appropriate timing (see FIG. 2), the video data VD is inputted to the other ends E2 of the FPCs 310. The video data VD inputted to the other end E2 of the FPCs 310 is converted into driving signals by the driver ICs 300 mounted on the FPCs 310 and outputted from the one ends E1 of the FPCS 310. The light-emitting elements 2951 are driven by the driving signals.

As explained above, in the third embodiment, as in the first and second embodiments, the FPCs 310 are provided on both the sides in the latitudinal direction LTD of the head substrate 293. Therefore, the wiring lines WL connected to the light-emitting elements 2951 can be drawn out in any direction of the head substrate 293 in the latitudinal direction LTD. A degree of freedom of the wiring lines WL connected to the light-emitting elements 2951 is improved.

In the third embodiment, the driver ICs 300 are provided between the one ends E1 and the other ends E2 of the FPCs 310 rather than on the head substrate 293. Therefore, since it is unnecessary to provide the driver ICs 300 on the head substrate 293, it is possible to reduce the size of the head substrate 293 and configure the line head 29 compact.

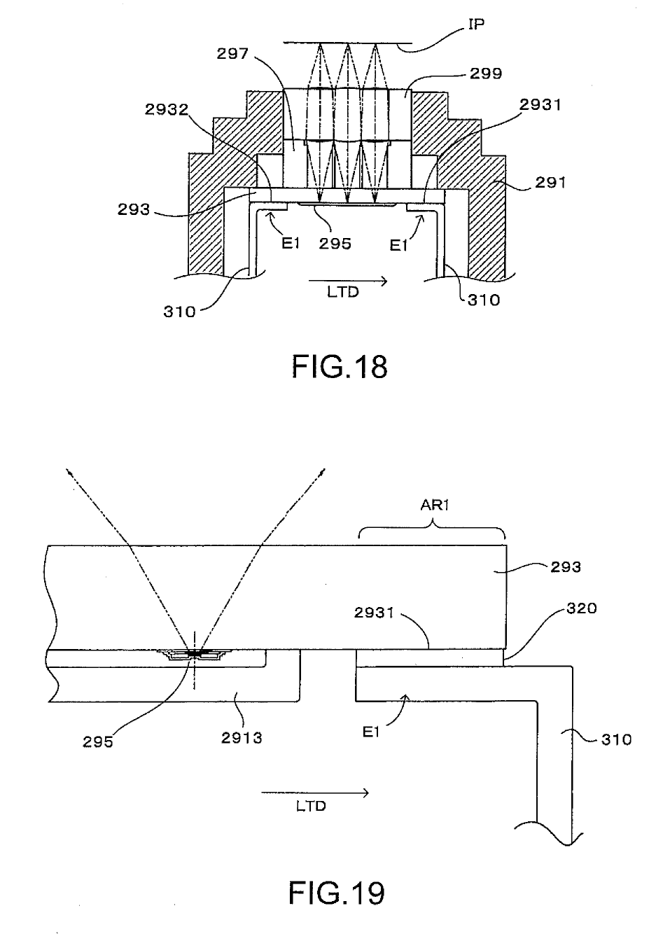

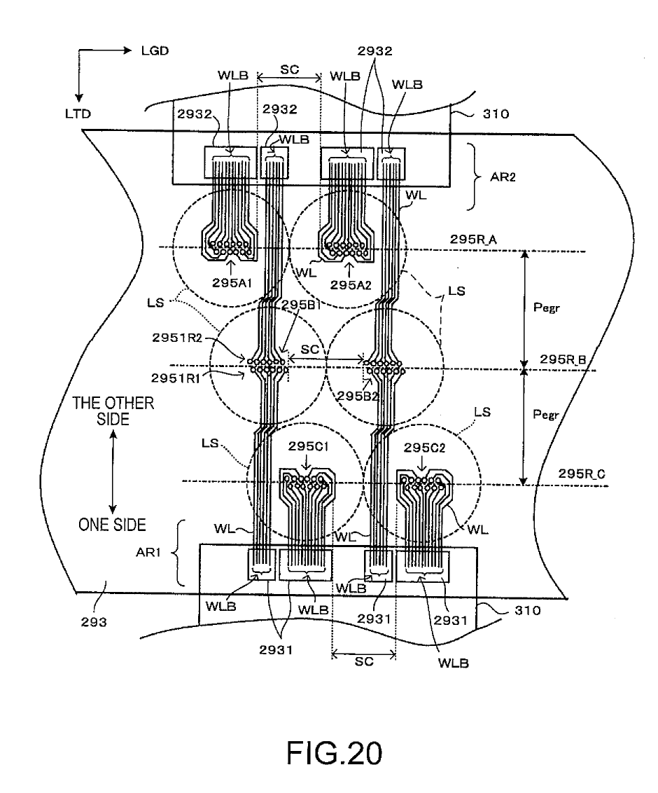

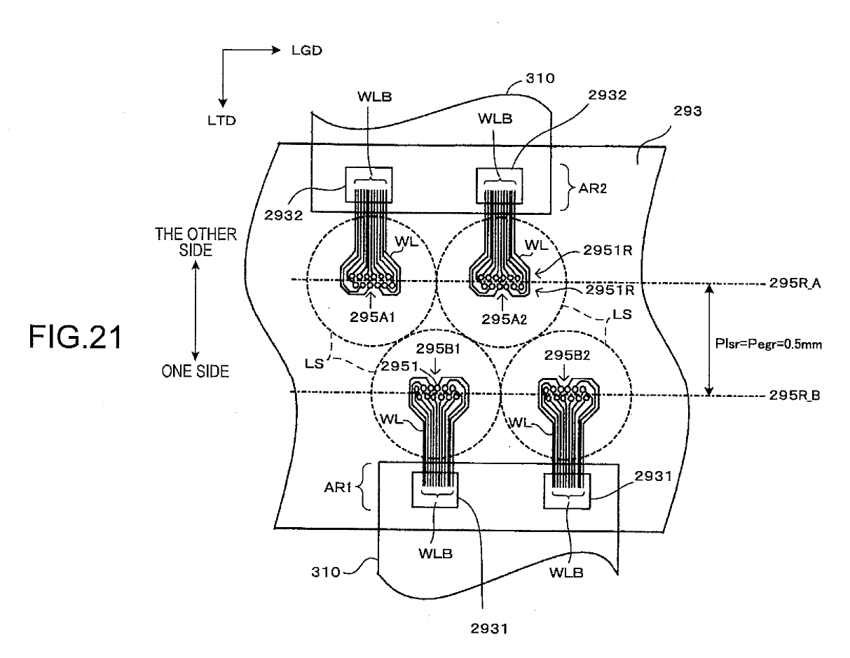

A form of attachment of FPCs to a head substrate according to the third embodiment is explained with reference to FIGS. 18 to 21. FIG. 18 is a sectional view in a latitudinal direction of a line head according to the third embodiment. FIG. 19 is a partially enlarged view of FIG. 18. FIGS. 20 and 21 are a main part plan view of the head substrate according to the third embodiment. The first connecting units 2931 are provided in the one area AR1 of the head substrate 293 and the second connecting units 2932 are provided in the other area AR2. The wiring line bundles WLB electrically connected to the light-emitting elements 2951 are electrically connected to the first connecting units 2931 and the second connecting units 2932. The first connecting units 2931 and the FPCs 310 are electrically connected to each other and the second connecting units 2932 and the FPCs 310 are electrically connected to each other by the anisotropic conductive films 320.

FIG. 20 is a diagram of a form in which the three light-emitting element group rows 295R are disposed from one side to the other side in the latitudinal direction LTD as in the first embodiment. The wiring lines WL (corresponding to the “first wiring line” of the invention) electrically connected to the light-emitting elements 2951 (corresponding to the “first light-emitting element” of the invention) belonging to the light-emitting element groups 295C1 and 295C2 (corresponding to the “first light-emitting element group” of the invention) included in the light-emitting element group row 295R_C (corresponding to the “first light-emitting element group row” of the invention) are electrically connected to the first connecting units 2931. The wiring lines WL (corresponding to the “second wiring line” of the invention) electrically connected to the light-emitting elements 2951 (corresponding to the “second light-emitting element” of the invention) belonging to the light-emitting element groups 295A1 and 295A2 (corresponding to the “second light-emitting element group” of the invention) included in the light-emitting element group row 295R_A (corresponding to the “Nth light-emitting element group row” of the invention) are electrically connected to the second connecting units 2932. The wiring lines WL electrically connected to the light-emitting elements 2951 belonging to the light-emitting element rows 2951R on one side among the light-emitting elements 2951 belonging to the light-emitting element group 295B1 and the light-emitting element group 295B2 included in the light-emitting element group row 295R_B are electrically connected to the first connecting units 2931. The wiring lines WL electrically connected to the light-emitting elements 2951 belonging to the light-emitting element rows 2951R2 on the other side are electrically connected to the second connecting units 2932.

FIG. 21 is a diagram of a form in which the two light-emitting element group rows 295R are disposed from one side to the other side in the latitudinal direction LTD as in the second embodiment. The wiring lines WL (corresponding to the “first wiring line” of the invention) electrically connected to the light-emitting elements 2951 (corresponding to the “first light-emitting element” of the invention) belonging to the light-emitting element groups 295B1 and 295B2 (corresponding to the “first light-emitting element group” of the invention) included in the light-emitting element group row 295R_B (corresponding to the “first light-emitting element group row” of the invention) are electrically connected to the first connecting units 2931. The wiring lines WL (corresponding to the “second wiring line” of the invention) electrically connected to the light-emitting elements 2951 (corresponding to the “second light-emitting element” of the invention) belonging to the light-emitting element groups 295A1 and 295A2 (corresponding to the “second light-emitting element group” of the invention) included in the light-emitting element group row 295R_A (corresponding to the “Nth light-emitting element group row” of the invention) are electrically connected to the second connecting unit 2932.

### E. Fourth Embodiment

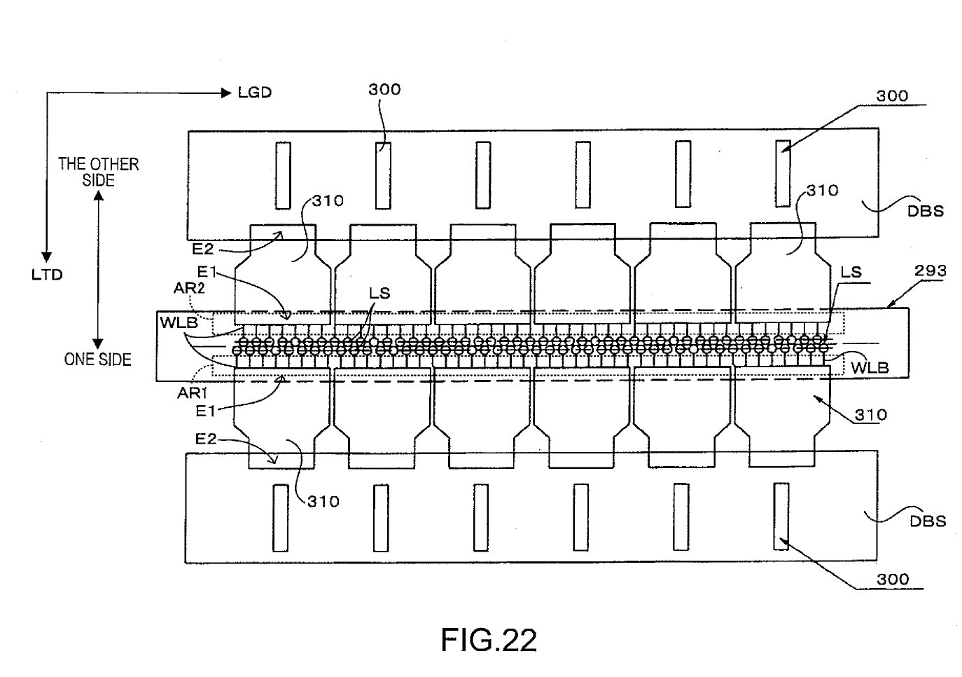

FIG. 22 is a diagram of an arrangement relation between wiring line bundles and driver ICs according to the fourth embodiment. Differences from the first to third embodiments are mainly explained below. Components same as those in the first to third embodiments are denoted by the same reference numerals and signs and explanation of the components is omitted. As shown in FIG. 22, the plurality of FPCs 310 are provided in the longitudinal direction LGD in each of the one area AR1 and the other area AR2 of the head substrate 293. The one ends E1 of the FPCs 310 are attached to the areas AR1 and AR2. In each of the one area AR1 and the other area AR2, the wiring line bundles WLB drawn out to the area AR1 or AR2, are connected to the one ends E1 of the FPCs 310.

The other ends E2 of the FPCs 310 are attached to substrates DBS for driver ICs. As shown in the figure, the substrates DBS for driver ICs are provided on both the sides of the head substrate 293 in the latitudinal direction LTD. The other ends E2 of the FPCs 310 attached to the one area AR1 are attached to the substrate DBS for driver ICs on one side of the head substrate 293. The other ends E2 of the FPCs 310 attached to the other area AR2 are attached to the substrate DBS for driver ICs on the other side of the head substrate 293. The other ends E2 of the FPCs 310 are connected to the driver ICs 300 mounted on the substrates DBS for driver ICs.

Video data VD from the head controller HC can be inputted to the driver ICs 300. When the head controller HC outputs video data VD at appropriate timing (see FIG. 2), the video data VD is converted in to driving signals by the driver ICs 300. The driving signals are inputted to the light-emitting elements 2951 via the FPCs 310. The light-emitting elements 2951 are driven by the driving signals.

As explained above, in the fourth embodiment, as in the first to third embodiments, the FPCs 310 are provided on both the sides in the latitudinal direction LTD of the head substrate 293. Therefore, the wiring lines WL connected to the light-emitting elements 2951 can be drawn out in any direction of the head substrate 293 in the latitudinal direction LTD. A degree of freedom of the wiring lines WL connected to the light-emitting elements 2951 is improved.

In the fourth embodiment, the plurality of driver ICs 300 are provided in the substrates DBS for driver ICs separate from the head substrate 293. Therefore, it is possible to relatively freely arrange and lay out the driver ICs 300 and hold down cost of the driver ICs 300.

### F. Fifth Embodiment

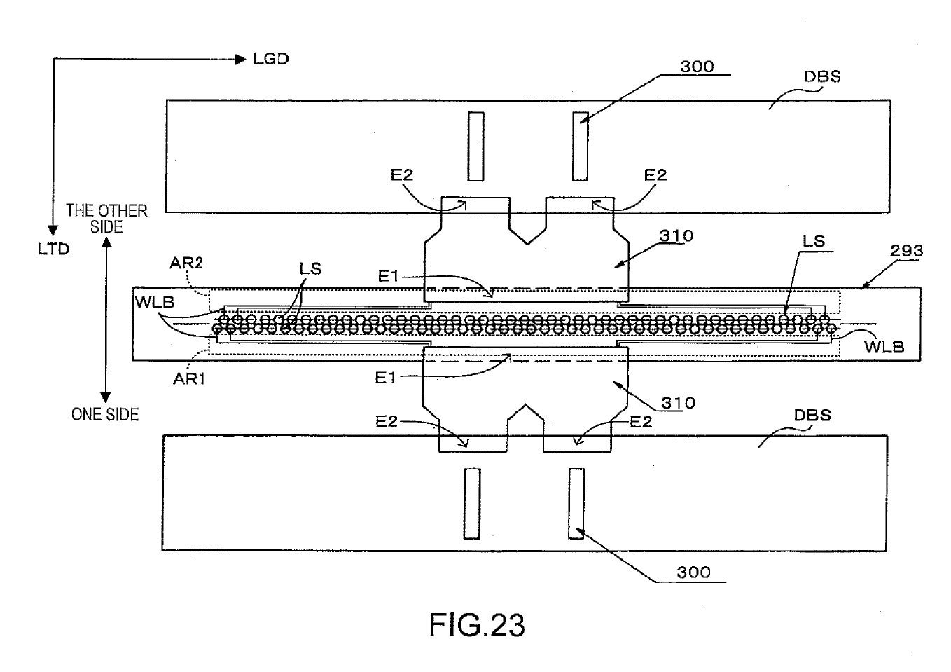

FIG. 23 is a diagram of an arrangement relation between wiring line bundles and driver ICs according to a fifth embodiment of the invention. In FIG. 23, only the wiring line bundles WLB drawn out from a part of the lenses LS are shown. Differences from the first to fourth embodiments are mainly explained below. Components same as those in the first to fourth embodiments are denoted by the same reference numerals and signs and explanation of the components is omitted. As shown in the figure, the wiring line bundles WLB drawn out from the lenses LS to the one area AR1 are collected in one location OL in the longitudinal direction LGD. Similarly, the wiring line bundles WLB drawn out from the lenses LS to the other area AR2 are collected in one location OL in the longitudinal direction LGD. A pair of the FPCs 310 are provided in the one area AR1 and the other area AR2, respectively. The one ends E1 of the FPCs 310 are attached to an area corresponding thereto (the one area AR1 or the other area AR2).

The other ends E2 of the FPCs 310 are attached to the substrates DBS for driver IC. As shown in the figure, the substrates DBS for driver ICs are provided on both the sides of the head substrate 293 in the latitudinal direction LTD. The other end E2 of the FPC 310 attached to the one area AR1 is attached to the substrate DBS for driver ICs on one side of the head substrate 293. The other end E2 of the FPC 310 attached to the other area AR2 are attached to the substrate DBS for driver ICs on the other wide of the head substrate 293. The other ends E2 of the FPCs 310 are connected to the driver ICs 300 mounted on the substrates DBS for driver ICs.

Video data VD from the head controller HC can be inputted to the driver ICs 300. When the head controller HC outputs video data VD at appropriate timing (see FIG. 2), the video data VD is converted into driving signals by the driver ICs 300. The driving signals are inputted to the light-emitting elements 2951 via the FPCs 310. The light-emitting elements 2951 are driven by the driving signals.

As explained above, in the fifth embodiment, as in the first to fourth embodiments, the FPCs 310 are provided on both the sides in the latitudinal direction LTD of the head substrate 293. Therefore, the wiring lines WL connected to the light-emitting elements 2951 can be drawn out in any direction of the head substrate 293 in the latitudinal direction LTD. A degree of freedom of the wiring lines WL connected to the light-emitting elements 2951 is improved.

In the fifth embodiment, in each of the one area AR1 and the other area AR2, the wiring lines WL drawn out to the area are collected in the one location OL in the longitudinal direction LGD. Therefore, in the fifth embodiment, one FPC 310 only has to be attached to the head substrate 293 in each of the first area AR1 and the other area AR2. Since steps for attaching the FPCs 310 can be reduced, it is possible to hold down manufacturing cost.

### G. Modifications

As explained above, in the first to fifth embodiments, the longitudinal direction LGD corresponds to the “first direction” of the invention, the latitudinal direction LTD corresponds to the “second direction” of the invention, the photosensitive drum 21 corresponds to the “latent image bearing member” of the invention, and the surface of the photosensitive drum 21 corresponds to the “image plane” of the invention. The FPCs 310 correspond to the “connecting members” of the invention, the one ends E1 of the FPCs 310 correspond to the “first ends” of the invention, and the other ends E2 of the FPCs 310 correspond to the “second ends” of the invention. The video data VD corresponds to the “light-emission control signal” of the invention and the video data VD and the driving signals corresponding to the “signals related to the light-emission control signal” of the invention. The FPCs 310 on one side in the latitudinal direction LTD correspond to the “first connecting circuit” of the invention and the FPCs 310 on the other aide correspond to the “second connecting circuit” of the invention. The driver ICs 300 on one side correspond to the “first electric circuit” of the invention and the driver ICs 300 on the other side correspond to the “second electric circuit” of the invention. The substrate DBS for driver ICs on one side corresponds to the “first driving substrate” of the invention and the substrate DBS for driver ICs on the other side corresponds to the “second driving substrate” of the invention.

The invention is not limited to the embodiments explained above. Various modifications of the embodiments are possible without departing from the spirit of the invention. For example, in the embodiments, the light-emitting element group 295 includes the two light-emitting element rows 2951R arranged in the latitudinal direction LTD. However, a form of configuration of the light-emitting element group 295 is not limited to this. For example, the light-emitting element group 295 may include a trio or more of the light-emitting element rows 2951R.

In the embodiment, the two or three light-emitting element group rows 295R are arranged in the latitudinal direction LTD. However, the number of the light-emitting element group rows 295R is not limited to this and only has to be two or more.

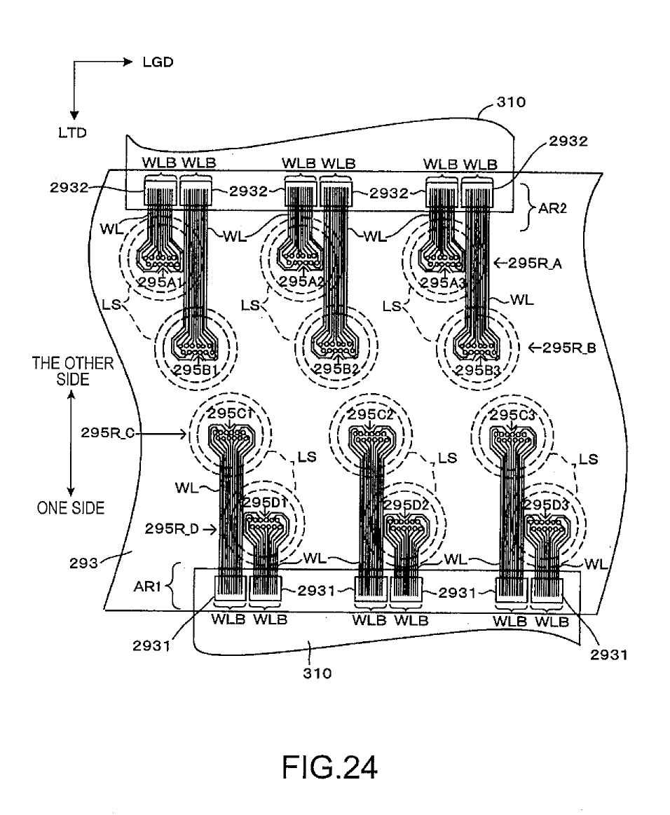

FIG. 24 is a main part plan view of a head substrate in a modification. In FIG. 24, four light-emitting element group rows 295R are disposed from one side to the other side in the latitudinal direction LTD on the head substrate 293. A light-emitting element group row 295R_D (corresponding to the “first light-emitting element group row” of the invention), a light-emitting element group row 295R_C (corresponding to the “second light-emitting element group row” of the invention) a light-emitting element group row 295R_B (corresponding to the “third light-emitting element group row” of the invention), and a light-emitting element group row 295R_A (corresponding to the “fourth light-emitting element group row” of the invention) are disposed from one side to the other side in the latitudinal direction LTD. The wiring lines WL from the light-emitting element group rows 295R_D and 295R_C are electrically connected to the first connecting unit 2931. The wiring lines WL from the light-emitting element group rows 295R_B and 295R_A are electrically connected to the second connecting units 2932. In this way, in the modification (corresponding to “M=2” of the invention) shown in FIG. 24, as in the embodiments, the wiring lines WL are equally distributed and drawn out to one side and the other side. Therefore, as in the embodiments, it is possible to improve a degree of freedom of wiring lines and reduce fluctuation in wiring length.

In the embodiments, the driver ICs 300 are used as the “electric circuits” of the invention. However, circuits other hand the driver ICs can also be used as the “electric circuits” of the invention.

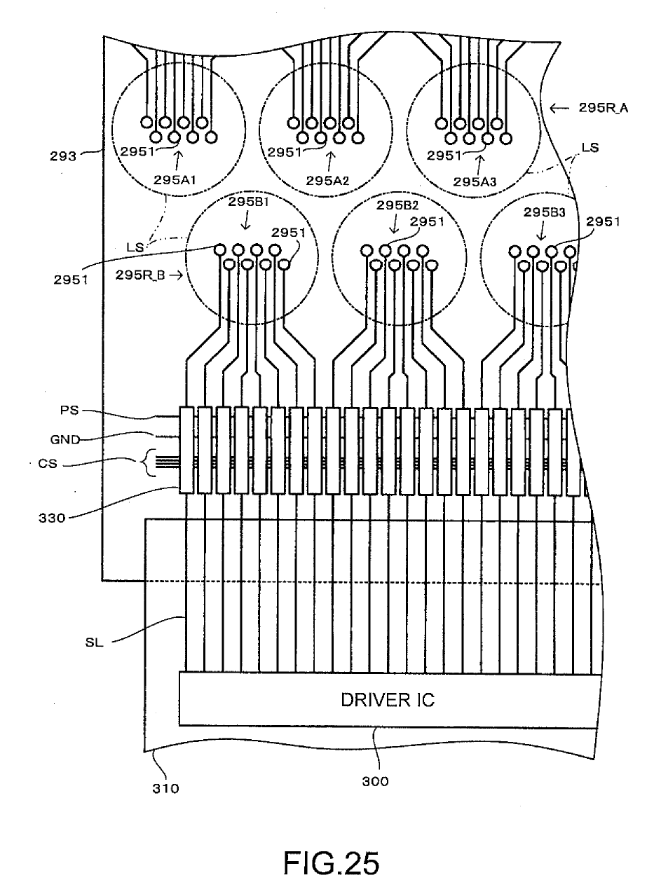

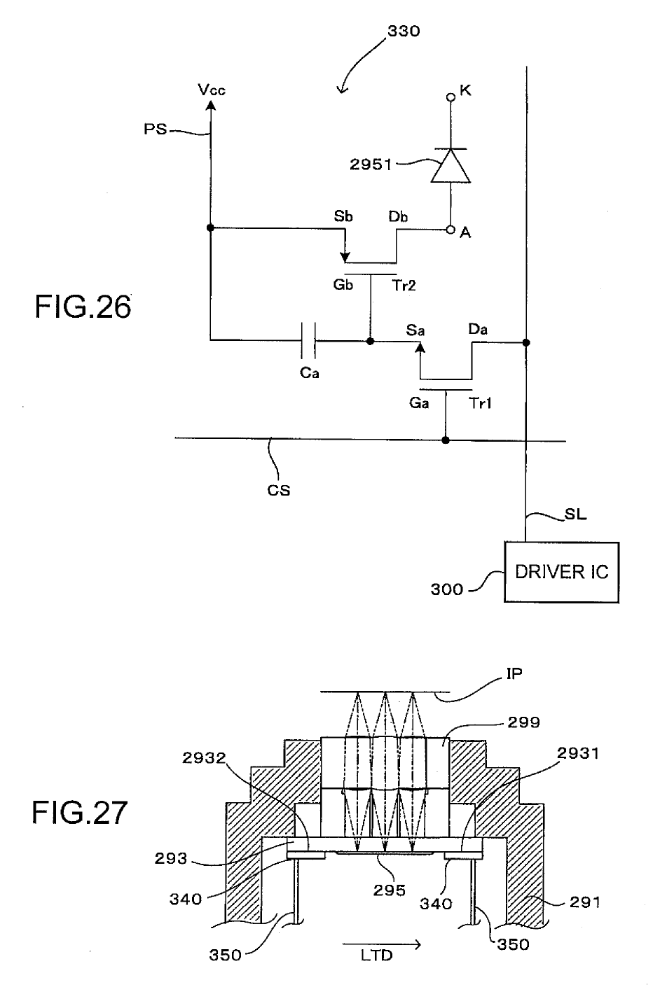

Moreover, for example, other circuits may be used in addition to the driver ICs. FIG. 25 is a diagram of an electric connection state of a form in which TFT (thin film transistor) circuits are used in addition to the driver ICs. FIG. 26 is a circuit diagram of an example of the TFT circuits. In FIG. 25, only an electric connection state is shown rather than a drawing-around state of wiring lines.

As shown in FIG. 25, signal lines SL electrically connected to the light-emitting elements 2951 are electrically connected to the driver IC 300, which is disposed in the FPC 310, via separate TFT circuits 330, respectively. Power supply lines PS, earth lines GND, and select signal lines CS are electrically connected to the TFT circuits 330, respectively. In FIG. 26, a cathode terminal K of the light-emitting element 2951 is connected to a not-shown power supply and an anode terminal A thereof is connected to a drain Db of a driving transistor Tr2. A source Sb of the driving transistor Tr2 is connected to the power supply line PS and a gate Gb thereof is connected to a source Sa of the switching transistor Tr1. The source Sa of the switching transistor Tr1 is connected to the power supply line PS via a storage capacitor Ca. A gate Ga of the switching transistor Tr1 is connected to the select signal line CS and a drain Da thereof is connected to the signal line SL.

Operations in the circuit diagram of FIG. 26 are explained. When an electric current is supplied to the select signal line CS and the signal line SL in a state in which voltage of the power supply line PS is applied to the source Sa of the switching transistor Tr1, the switching transistor Tr1 is turned on. Therefore, the gate voltage of the driving transistor Tr2 falls, the voltage of the power supply line PS is supplied from the source Sb of the driving transistor Tr2, and the driving transistor Tr2 becomes conductive. As a result, the light-emitting element 2951 operates to emit light with a predetermined light amount. The light amount of the light-emitting element 2951 depends on a signal level outputted from the driver IC 300 to the signal line SL.

When the driving transistor Tr2 becomes conductive, the storage capacitor Ca is charged by the voltage of the power supply line PS. Therefore, when the switching transistor Tr1 is turned off, the driving transistor Tr2 is also in the conductive state on the basis of the electric charges charged in the storage capacitor Ca. The light-emitting element 2951 maintains the light-emitting state. Therefore, when an active matrix is applied to a driving circuit for the light-emitting element 2951, even when the switching transistor Tr1 is turned off in order to transfer output signals of the driver IC 300 through a shift register, it is possible to maintain the light-emitting state of the light-emitting element 2951 and perform exposure with high luminance.

According to this modification, since the TFT circuit 330 (corresponding to the “first holding circuit” and the “second holding circuit” of the invention) is used in addition to the driver IC 300 (corresponding to the “first driving circuit” and the “second driving circuit” of the invention), the light-emitting state of the light-emitting element 2951 can be maintained even when the switching transistor Tr1 is turned off. Therefore, a circuit configuration of the driver IC 300 can be simplified. The TFT circuit 330 shown in FIG. 26 is a publicly-known circuit disclosed in JP-A-2003-341140. However, the TFT circuit 330 is not limited to that shown in FIG. 26 and other publicly-known circuits can be adopted.

The light-emitting elements 2951 can be driven by so-called time division driving. The driving by the time division driving can be performed according to a technique proposed in the past, for example, a technique disclosed in JP-A-11-268333, JP-A-2007-203555, or JP-A-2007-160650. With such a configuration, it is possible to reduce the number of driver ICs and hold down manufacturing cost.

In the embodiments, organic EL elements are used as the light-emitting elements 2951. However, a configuration of the light-emitting elements 2951 is not limited to this. For example, LEDs (Light Emitting Diodes) may be used.

In the embodiments, the FPCs 310 are used as the “connecting members”. In the first and second embodiments, the FPCs 310, to the other ends E2 of which video data VD is inputted and from the one ends E1 of which the video data VD is outputted, function as the “connecting members”. In the third embodiment, the FPCs 310, to the other ends E2 of which video data VD is inputted and from the one ends E1 of which driving signals obtained by converting the video data VD are outputted, function as the “connecting members”. In the fourth and fifth embodiments, the FPCs 310, to the other ends E2 of which driving signals are inputted and from the one ends E1 of which the driving signals are outputted, function as the “connecting members”. However, like the FPCS 310, other members, from the one ends E1 of which signals corresponding to signals inputted to the other ends E2 can be outputted, can also be used as the “connecting members”.

For example, FIG. 27 is a diagram of a form in which FFCs (Flexible Flat Cables) are used. In a modification shown in FIG. 27, connectors 340 are disposed in the first connecting unit 2931 and the second connecting unit 2932 of the head substrate 293, respectively. FFCs 350 (corresponding to the “first connecting circuit” and the “second connecting circuit” of the invention) are connected to the connectors 340. In this modification, as in the embodiments, it is possible to improve a degree of freedom of wiring lines and suppress fluctuation in wiring length.

What is claimed is:

1. A line head comprising:
a head substrate;
a first light-emitting element group having first light-emitting elements;
a second light-emitting element group having second light-emitting elements;
a first wiring line disposed on the head substrate and electrically connected to the first light-emitting elements;
a second wiring line disposed on the head substrate and electrically connected to the second light-emitting elements;
a first connecting unit disposed on one side of the head substrate and electrically connected to the first wiring line; and
a second connecting unit disposed on the other side of the head substrate and electrically connected to the second wiring line.

2. The line head according to claim 1, wherein
on the head substrate, N (N is an integer equal to or larger than 2) light-emitting element group rows having light-emitting element groups disposed in a first direction are disposed from one side to the other side in a second direction orthogonal to or substantially orthogonal to the first direction,
the first light-emitting element group is included in a first light-emitting element group row, and
the second light-emitting element group is included in an Nth light-emitting element group row.

3. The line head according to claim 1, wherein
on the head substrate, 2M (M is a positive integer) light-emitting element group rows having light-emitting element groups disposed in the first direction are disposed from one side to the other side in the second direction orthogonal to or substantially orthogonal to the first direction,
the first light-emitting element group is included in any one of a first light-emitting element group row to an Mth light-emitting element group row, and
the second light-emitting element group is included in any one of an (M+1)th light-emitting element group row to a 2Mth light-emitting element group row.

4. The line head according to claim 3, wherein
wiring lines electrically connected to the light-emitting elements belonging to the first light-emitting element group row to the Mth light-emitting element group row are electrically connected to the first connecting unit, and
wiring lines electrically connected to the light-emitting elements belonging to the (M+1)th light-emitting element group row to the 2Mth light-emitting element group row are electrically connected to the second connecting unit.

5. The line head according to claim 1, further comprising:
a first connecting circuit electrically connected to the first connecting unit of the head substrate; and
a second connecting circuit electrically connected to the second connecting unit of the head substrate.

6. The line head according to claim 5, further comprising:
a first electric circuit that is electrically connected to the first connecting unit of the head substrate via the first connecting circuit and outputs driving signals for driving the light-emitting elements on the basis of an inputted light-emission control signal; and
a second electric circuit that is electrically connected to the second connecting unit of the head substrate via the second connecting circuit and outputs driving signals for driving the light-emitting elements on the basis of an inputted light-emission control signal.

7. The line head according to claim 6, further comprising:
a first driving substrate on which the first electric circuit is disposed; and
a second driving substrate on which the second electric circuit is disposed.

8. The line head according to claim 5, further comprising:
a first electric circuit that is electrically connected to the first connecting unit of the head substrate not via the first connecting circuit and outputs driving signals for driving the light-emitting elements on the basis of an inputted light-emission control signal; and
a second electric circuit that is electrically connected to the second connecting unit of the head substrate not via the second connecting circuit and outputs driving signals for driving the light-emitting elements on the basis of an inputted light-emission control signal, wherein
the first electric circuit and the second electric circuit are disposed on the head substrate.

9. The line head according to claim 5, further comprising:
a first electric circuit that is provided in the first connecting circuit and outputs driving signals for driving the light-emitting elements on the basis of an inputted light-emission control signal; and
a second electric circuit that is provided in the second connecting circuit and outputs driving signals for driving the light-emitting elements on the basis of an inputted light-emission control signal.

10. The line head according to claim 5, further comprising:
a first driving circuit that is provided in the first connecting circuit and outputs driving signals corresponding to amounts of emitted light of the light-emitting elements on the basis of an inputted light-emission control signal;
a first holding circuit that is provided in the wiring lines electrically connected to the first connecting unit of the head substrate and holds the driving signals outputted from the first driving circuit;
a second driving circuit that is provided in the second connecting circuit and outputs driving signals corresponding to amounts of emitted light of the light-emitting elements on the basis of an inputted light-emission control signal; and
a second holding circuit that is provided in the wiring lines electrically connected to the second connecting unit of the head substrate and holds the driving signals outputted from the second driving circuit.

11. An image forming apparatus comprising:
a head substrate;
a first light-emitting element group having first light-emitting elements;
a second light-emitting element group having second light-emitting elements;
a first wiring line disposed on the head substrate and electrically connected to the first light-emitting elements;
a second wiring line disposed on the head substrate and electrically connected to the second light-emitting elements;
a first connecting unit disposed on one side of the head substrate and electrically connected to the first wiring line;
a second connecting unit disposed on the other side of the head substrate and electrically connected to the second wiring line, and
a controller that outputs a light-emission control signal for controlling light emission of the light-emitting elements.

12. The image forming apparatus according to claim 11, further comprising:
a first connecting circuit electrically connected to the first connecting unit of the head substrate; and
a second connecting circuit electrically connected to the second connecting unit of the head substrate.

13. The image forming apparatus according to claim 12, further comprising:
a first electric circuit that is electrically connected to the first connecting unit of the head substrate via the first connecting circuit and outputs driving signals for driving the light-emitting elements on the basis of an inputted light-emission control signal; and
a second electric circuit that is electrically connected to the second connecting unit of the head substrate via the second connecting circuit and outputs driving signals for driving the light-emitting elements on the basis of an inputted light-emission control signal.

14. The image forming apparatus according to claim 12, further comprising:
a first electric circuit that is electrically connected to the first connecting unit of the head substrate not via the first connecting circuit and outputs driving signals for driving the light-emitting elements on the basis of an inputted light-emission control signal; and
a second electric circuit that is electrically connected to the second connecting unit of the head substrate not via the second connecting circuit and outputs driving signals for driving the light-emitting elements on the basis of an inputted light-emission control signal.

15. The image forming apparatus according to claim 12, further comprising:
a first driving circuit that is provided in the first connecting circuit and outputs driving signals corresponding to amounts of emitted light of the light-emitting elements on the basis of an inputted light-emission control signal;
a first holding circuit that is provided in the wiring lines electrically connected to the first connecting unit of the head substrate and holds the driving signals outputted from the first driving circuit;
a second driving circuit that is provided in the second connecting circuit and outputs a driving signals corresponding to amounts of emitted light of the light-emitting elements on the basis of an inputted light-emission control signal; and
a second holding circuit that is provided in the wiring lines electrically connected to the second connecting unit of the head substrate and holds the driving signals outputted from the second driving circuit.
